(19) United States
(12) Patent Application Publication
(10) Pub. No.: US 2013/0107968 A1
(43) Pub. Date: May 2, 2013

(54) Image Processing Device and Method

(71) Applicant: Kazushi Sato, Kanagawa (JP)

(72) Inventor: Kazushi Sato, Kanagawa (JP)

(73) Assignee: Sony Corporation, Tokyo (JP)

(21) Appl. No.: 13/808,665

(22) PCT Filed: Jul. 1, 2011
(86) PCT No.: PCT/JP2011/065209

§ 371 Date: Jan. 7, 2013

(30) Foreign Application Priority Data
Jul. 9, 2010 (JP) 2010-156706

(51) Int. Cl. H04N 7/26

(52) U.S. Cl. CPC H04N 19/00696
USPC 375/240.16

(57) ABSTRACT

The present disclosure relates to an image processing device and method whereby encoding efficiency can be improved. An image processing device includes a motion prediction/compensation unit configured to perform motion prediction/compensation in a prediction mode regarding which there is no need to transmit a generated motion vector to a decoding side, and in which the motion vector is generated with regard to a motion partition which is a partial region of an image to be encoded and is a non-square motion prediction/compensation processing increment, the generating being performed using motion vectors of surrounding motion partitions that have already been generated; and an encoding unit configured to encode difference information between a prediction image generated by motion prediction/compensation performed by the motion prediction/compensation unit, and the image. The present technology can be applied to an image processing device, for example.

### TECHNICAL FIELD

The present technology relates to an image processing device and method, and specifically relates to an image processing device and method which enable higher encoding efficiency to be realized.

### BACKGROUND ART

In recent years, devices, which subject an image to compression encoding by employing an encoding format handling image information as digital signals, and at this time compress the image by orthogonal transform such as discrete cosine transform or the like and motion compensation, taking advantage of redundancy which is a feature of the image information, in order to perform highly efficient transmission and storage of information are coming into widespread use in both information transmission such as broadcasting stations and information reception in homes. Examples of this encoding method include MPEG (Moving Picture Experts Group) and so forth.

In particular, MPEG2 (ISO (International. Organization for Standardization)/IEC (International Electrotechnical Commission) 13818-2) is defined as a general-purpose image encoding format, and is a standard encompassing both of interlaced scanning images and sequential-scanning images, and standard resolution images and high definition images. For example, MPEG2 has widely been employed now by broad range of applications for professional usage and for consumer usage. By employing the MPEG2 compression format, a code amount (bit rate) of 4 through 8 Mbps is allocated in the event of an interlaced scanning image of standard resolution having 720×480 pixels, for example. By employing the MPEG2 compression format, a code amount (bit rate) of 18 through 22 Mbps is allocated in the event of an interlaced scanning image of high resolution having 1920×1088 pixels, for example, whereby a high compression rate and excellent image quality can be realized.

MPEG2 has principally been aimed at high image quality encoding adapted to broadcasting usage, but does not handle lower code amount (bit rate) than the code amount of MPEG1, i.e., an encoding format having a higher compression rate. It is expected that demand, for such an encoding format will increase from now on due to the spread of personal digital assistants, and in response to this, standardization of the MPEG4 encoding format has been performed. With regard to an image encoding format, the specification thereof was confirmed as an international standard as ISO/IEC 14496-2 in December in 1998.

Further, in recent years, standardization of a standard called H.26L (ITU-T (International Telecommunication Union Telecommunication Standardization Sector) Q6/16 VCEG (Video Coding Expert Group)) has progressed with image encoding for television conference usage as the object. It has been known that though greater computation amount is required for encoding and decoding with H.26L as compared to conventional encoding methods such as MPEG2 and MPEG4, higher encoding efficiency is realized. Also, currently, as part of activity of MPEG4, standardization for taking advantage of a function that is not supported by H.26L based on this H.26L, to realize higher encoding efficiency, has been performed as Joint Model of Enhanced-Compression Video Coding.

As a schedule of standardization, H.264 and MPEG-4 Part10 (Advanced Video Coding, hereafter referred to as AVC) become an international standard in March, 2003.

Now, a conventional macroblock size of 16×16 pixels is not optimal for large image frames such as UHD (Ultra High Definition; 4000×2000 pixels) which will be handled by next-generation encoding methods. Accordingly, NPL 1 and so forth propose enlarging the macroblock size to a size of 64×64 pixels, 32×32 pixels, or the like.

That is to say, with NPL 1, by employing a hierarchical structure, blocks of 16×16 pixels and smaller maintain compatibility with macroblocks in the current AVC, while larger blocks are defined as supersets thereof.

These blocks (macroblocks, and sub macroblocks where the macroblocks are divided into multiple regions) are used as motion partitions which are increments of motion prediction/compensation processing.

Now, with the AVC encoding format, skip mode and direct mode are provided. The skip mode and direct mode have no need to transmit motion vector information, and in particular, are employed for greater regions, thereby contributing to improved encoding efficiency.

### CITATION LIST

### Non Patent Literature

NPL 1: Peisong Chenn, Yan Ye, Marta Karczewicz, “Video Coding Using Extended Block Sizes”, COM16-C123-E, Qualcomm Inc, January 2009

### SUMMARY OF INVENTION

### Technical Problem

However, with the technique proposed with NPL 1, skip mode and direct mode are applied only to square blocks of the blocks which are motion partitions, so there has been the concern that encoding efficiency might not improve.

The present disclosure has been made in light of such a situation, and it is an object thereof to enable skip mode and direct mode to be applied to rectangular blocks, as well, and to improve encoding efficiency.

### Solution to Problem

One aspect of the present disclosure is an image processing device, including: a motion prediction/compensation unit configured to perform motion prediction/compensation in a prediction mode regarding which there is no need to transmit a generated motion vector to a decoding side, and in which the motion vector is generated with regard to a motion partition which is a partial region of an image to be encoded and is a non-square motion prediction/compensation processing increment, the generating being performed using motion vectors of surrounding motion partitions that have already been generated; and an encoding unit configured to encode difference information between a prediction image generated by motion prediction/compensation performed by the motion prediction/compensation unit, and the image.

The image processing device may further include a flag generating unit configured to generate, in the event of the motion prediction/compensation unit performing motion prediction/compensation as to the non-square motion partition, flag information indicating whether or not to perform motion prediction/compensation in the prediction mode.

In the event of the motion prediction/compensation unit performing motion prediction/compensation as to the non-square motion partition in the prediction mode, the flag generating unit may set the value of the flag information to 1, and in the event of performing motion prediction/compensation in a mode other than the prediction mode, set the flag information value to 0.

The encoding unit may encode the flag information generated by the flag generating unit along with the difference information.

The motion partition may be a non-square sub macroblock, dividing a macroblock, which is a partial region of the image to be encoded, and which is an encoding processing increment, and which is greater than a predetermined size, into a plurality.

The predetermined size may be 16×16 pixels.

The sub macroblock may be a rectangle.

The sub macroblock is a region dividing the macroblock into two.

The sub macroblock may be a region asymmetrically dividing the macroblock into two.

The sub macroblock may be a region obliquely dividing the macroblock into two.

An aspect of the present disclosure is also an image processing method of an image processing device, the method including: a motion prediction/compensation unit performing motion prediction/compensation in a prediction mode regarding which there is no need to transmit a generated motion vector to a decoding side, and in which the motion vector is generated with regard to a motion partition which is a partial region of an image to be encoded and is a non-square motion prediction/compensation processing increment, the generating being performed using motion vectors of surrounding motion partitions that have already been generated; and an encoding unit encoding difference information between a prediction image generated by motion prediction/compensation that has been performed, and the image.

Another aspect of the present disclosure is an image processing device, including: a decoding unit configured to decode a code stream in which is encoded different information between a prediction image generated by having performed motion prediction/compensation in a prediction mode regarding which there is no need to transmit a generated motion vector to a decoding side, and in which the motion vector is generated with regard to a motion partition which is a partial region of an image to be encoded and is a non-square motion prediction/compensation processing increment, the generating being performed using motion vectors of surrounding motion partitions that have already been generated, and the image; a motion prediction/compensation unit configured to perform motion prediction/compensation on the non-square motion partition in the prediction mode, generate the motion vector using motion vector information of the surrounding motion partitions obtained by the code stream having been decoded by the decoding unit, and generate the prediction image; and a generating unit configured to generate a decoded image by adding the difference information obtained by the code stream having been decoded by the decoding unit, and the prediction image generated by the motion prediction/compensation unit.

The motion prediction/compensation unit may perform motion prediction/compensation of the non-square motion partition in the prediction mode, in the event that flag information which has been decoded by the decoding unit and which indicates whether or not motion prediction/compensation has been performed in the prediction mode, indicates that the non-square motion partition has been subjected to motion prediction/compensation in the prediction mode.

The motion partition may be a non-square sub macroblock, dividing a macroblock, which is a partial region of the image to be encoded, and which is an encoding processing increment, and which is greater than a predetermined size, into a plurality.

The predetermined size may be 16×16 pixels.

The sub macroblock may be a rectangle.

The sub macroblock may be a region dividing the macroblock into two.

The sub macroblock may be a region asymmetrically dividing the macroblock into two.

The sub macroblock may be a region obliquely dividing the macroblock into two.

Another aspect of the present disclosure is an image processing method of an image processing device, the method including: a decoding unit decoding a code stream in which is encoded different information between a prediction image generated by having performed motion prediction/compensation in a prediction mode regarding which there is no need to transmit a generated motion vector to a decoding side, and in which the motion vector is generated with regard to a motion partition which is a partial region of an image to be encoded and is a non-square motion prediction/compensation processing increment, the generating being performed using motion vectors of surrounding motion partitions that have already been generated, and the image; a motion prediction/compensation unit performing motion prediction/compensation on the non-square motion partition in the prediction mode, generating the motion vector using motion vector information of the surrounding motion partitions obtained by the code stream having been decoded, and generating the prediction image; and a generating unit generating a decoded image by adding the difference information obtained by the code stream having been decoded, and the generated prediction image.

With one aspect of the present disclosure, motion prediction/compensation is performed in a prediction mode regarding which there is no need to transmit a generated motion vector to a decoding side, and in which the motion vector is generated with regard to a motion partition which is a partial region of an image to be encoded and is a non-square motion prediction/compensation processing increment, the generating being performed using motion vectors of surrounding motion partitions that have already been generated; and difference information between a prediction image generated by motion prediction/compensation that has been performed, and the image, is encoded.

With another aspect of the present disclosure, a code stream is decoded, in which is encoded different information between a prediction image generated by having performed motion prediction/compensation in a prediction mode regarding which there is no need to transmit a generated motion vector to a decoding side, and in which the motion vector is generated with regard to a motion partition which is a partial region of an image to be encoded and is a non-square motion prediction/compensation processing increment, the generating being performed using motion vectors of surrounding motion partitions that have already been generated, and the image; motion prediction/compensation is performed on the non-square motion partition in the prediction mode, the motion vector is generated using motion vector information of the surrounding motion partitions obtained by the code stream having been decoded, and the prediction image is generated; and a decoded image is generated by adding the difference information obtained by the code stream having been decoded, and the generated prediction image.

### Advantageous Effects of Invention

According to the present disclosure, an image can be processed. In particular, encoding efficiency can be improved.

### BRIEF DESCRIPTION OF DRAWINGS

FIG. 1 is a diagram illustrating an example of decimal pixel precision motion prediction/compensation processing.

FIG. 2 is a diagram illustrating examples of macroblocks.

FIG. 3 is a diagram for describing an example of how median operation is carried out.

FIG. 4 is a diagram for describing an example of multi reference frames.

FIG. 5 is a diagram for describing an example of how temporal direct mode is carried out.

FIG. 6 is a diagram illustrating another example of macroblocks.

FIG. 7 is a block diagram illustrating a primary configuration of an image encoring device.

FIG. 8 is a block diagram illustrating a detailed configuration example of a motion prediction/compensation unit.

FIG. 9 is a block diagram illustrating a detailed configuration example of a cost function calculating unit.

FIG. 10 is a block diagram illustrating a detailed configuration example of a rectangular skip/direct encoding unit.

FIG. 11 is a flowchart for describing an example of the flow of encoding processing.

FIG. 12 is a flowchart for describing the flow of inter motion prediction processing.

FIG. 13 is a flowchart for describing an example of the flow of rectangular skip/direct motion vector information generating processing.

FIG. 14 is a block diagram illustrating a primary configuration example of the image decoding device.

FIG. 15 is a block diagram illustrating a detailed configuration example of a motion prediction/compensation unit.

FIG. 16 is a block diagram illustrating a detailed configuration example of a rectangular skip/direct decoding unit.

FIG. 17 is a flowchart for describing an example of the flow of decoding processing.

FIG. 18 is a flowchart for describing an example of the flow of prediction processing.

FIG. 19 is a flowchart for describing an example of the flow of inter prediction processing.

FIG. 20 is a diagram for describing a technique described in NPL 2.

FIG. 21 is a diagram for describing a technique described in NPL 3.

FIG. 22 is a diagram for describing a technique described, in NPL 4.

FIG. 23 is a block diagram illustrating a primary configuration example of a personal computer.

FIG. 24 is a block diagram illustrating a principal configuration example of a television receiver.

FIG. 25 is a block diagram illustrating a principal configuration example of a cellular phone.

FIG. 26 is a block diagram illustrating a principal configuration example of a hard disk recorder.

FIG. 27 is a block diagram illustrating a principal configuration example of a camera.

### DESCRIPTION OF EMBODIMENTS

Hereinafter, embodiments for carrying out the present technology (hereinafter referred to as embodiments) will be described. Note that description will proceed in the following order.

1. First Embodiment (image encoding device)
2. Second Embodiment (image decoding device)
3. Third Embodiment (personal computer)
4. Fourth Embodiment (television receiver)
5. Fifth. Embodiment (cellular telephone)
6. Sixth Embodiment (hard disk recorder)
7. Seventh Embodiment (camera)

### 1. First Embodiment

[Motion Prediction/Compensation Processing with Decimal Pixel Precision]

With encoding formats such as MPEG2 or the like, motion prediction/compensation processing with ½ pixel precision has been performed by linear interpolation processing, while with the AVC encoding format, prediction/compensation processing with ¼ pixel precision using 6-tap FIR (Finite Impulse Response Filter) filter as an interpolation filter has been performed, and accordingly, encoding efficiency has improved.

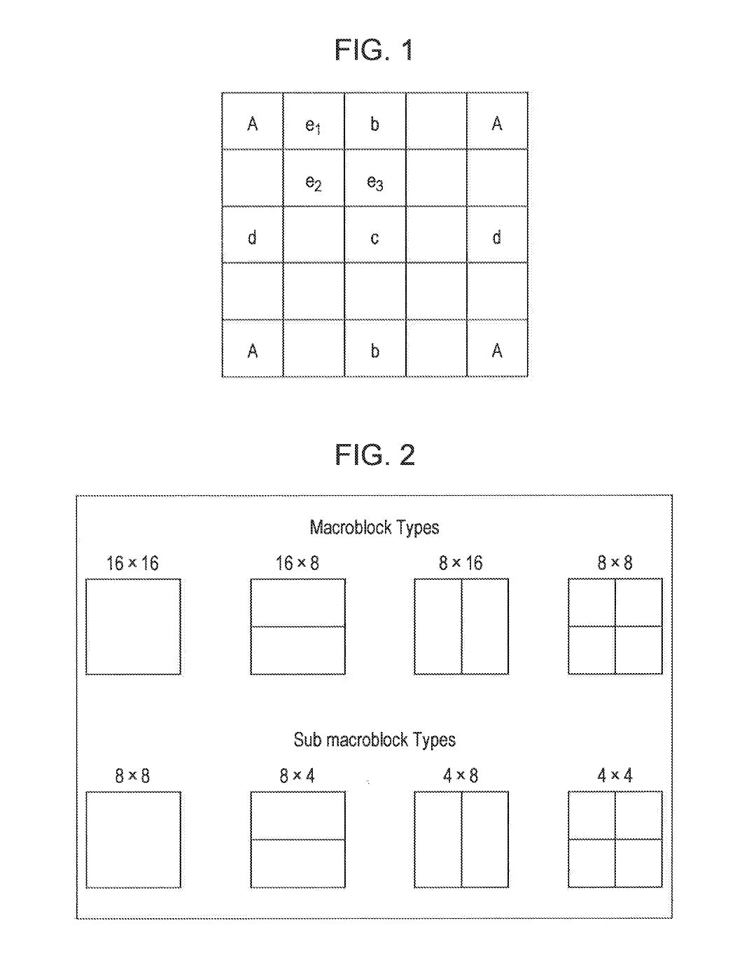

FIG. 1 is a diagram for describing prediction/compensation processing with ¼ pixel precision stipulated in the AVC encoding format. In FIG. 1, the squares represent pixels. Of these, the “A”s indicate the positions of integer precision pixels stored in frame memory 112, positions b, c, and d indicate positions with ½ pixel precision, and positions e1, e2, and e3 indicate positions with ¼ pixel precision.

Hereinafter, function Clip1( ) is defined as with the following Expression (1)

$$\begin{matrix}[ Mathematical Expression 1 ] & \\ Clip 1 ( a ) = \{ \begin{matrix}0 ; & if ( a < 0 ) \\ a ; & otherwise \\ max\_pix ; & if ( a > max\_pix )\end{matrix} & ( 1 )\end{matrix}$$

For example, in the event that the input image has 8-bit precision, the value of max_pix in Expression (1) is 255.

The pixel values in the positions b and d are generated as with the following Expression (2) and Expression (3) using a 6-tap FIR filter.

[Mathematical Expression 2]

F=A₋₂−5·A₋₁+20·A₀+20·A₁−5·A₂+A₃ (2)

[Mathematical Expression 3]

b,d=clip1((F+16)>>5) (3)

The pixel value in the position c is generated as with the following Expression (4) through Expression (6) by applying a 6-tap FIR filter in the horizontal direction and the vertical direction.

[Mathematical Expression 4]

F=b₋₂−5·b₋₁+20·b₀+20·b₁−5·b₂+b₃ (4)

or

[Mathematical Expression 5]

F=d₋₂−5·d₋₁+20·d₀+20·d₁−5·d₂+d₃ (5)

[Mathematical Expression 6]

c=Clip1((F+512)>>10) (6)

Note that Clip processing is executed only once at the end, after both of sum-of-products processing in the horizontal direction and the vertical direction are performed.

e1 through e3 are generated by linear interpolation as shown in the following Expression (7) through Expression (9)

[Mathematical Expression 7]

e₁=(A+b+1)>>1 (7)

[Mathematical Expression 8]

e₂=(b+d+1)>>1 (8)

[Mathematical Expression 9]

e₃=(b+c+1)>>1 (9)

### [Motion Prediction/Compensation Processing]

Also, with MPEG2, in the event of the frame motion comuensation mode, motion prediction/compensation processing is performed in increments of 16×16 pixels, and in the event of the field motion compensation mode, motion prediction/compensation processing is performed as to each of the first field and the second field in increments of 16×8 pixels.

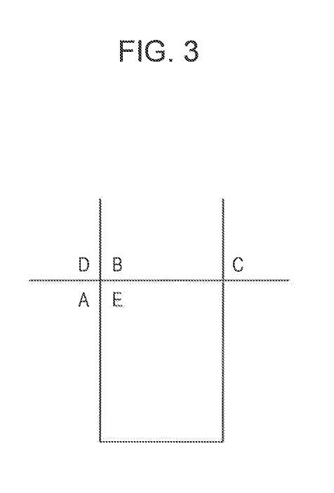

On the other hand, with AVC, as shown in FIG. 2, one macroblock configured of 16×16-pixels can be divided into one of 16×16-pixel, 16×8-pixel, 8×16-pixel, and 8×8-pixel partitions, with each sub macroblock having independent motion vector information. Also, as shown in FIG. 3, an 8×8-pixel partition may be divided into one of 8×8-pixel, 8×4-pixel, 4×8-pixel, and 4×4-pixel sub partitions with each sub macroblock having independent motion vector information.

However, with the AVC image encoding format, performing such motion prediction/compensation processing in the same way as with MPEG-2 could result in vast amounts of motion vector information being generated. If the generated motion vector information is encoded without change, deterioration in encoding efficiency could be caused.

As a technique to solve this problem, with the AVC image encoding format, reduction in motion vector coding information has been realized, according to the following technique.

The lines in FIG. 3 represent boundaries of motion compensation blocks. Also, in FIG. 3, E represents a current motion compensation block to be encoded from now, and A through D represent motion compensation blocks which have already been encoded, adjacent to the current block E.

Let us say that with X=A, B, C, D, E, motion vector information as to X is represented with mvₓ.

First, prediction motion vector information pmv_{E} as to the motion compensation block E is generated as with the following Expression (10) by median operation using motion vector information regarding the motion compensation blocks A, B, and C.

[Mathematical Expression 10]

pmv_{E}=med(mv_{A},mv_{B},mv_{C}) (10)

In the event that the motion vector information regarding the block C is “unavailable” due to a reason such as being at the edge of an image frame, the motion vector information regarding the block D is used instead.

Data mvd_{E} to be encoded as the motion vector information as to the current block E, is generated as with the following Expression (11) using pmv_{E}.

[Mathematical Expression 11]

mvd_{E}=mv_{E}−pmv_{E} (11)

Note that, in actual processing, processing is independently performed as to the components in the horizontal direction and vertical direction of the motion vector information.

Also, with AVC, there is stipulated a format called Multi-Reference Frame (multi (plural) reference frame), which had not been stipulated with conventional image encoding formats such as MPEG-2 and H.263 and so forth.

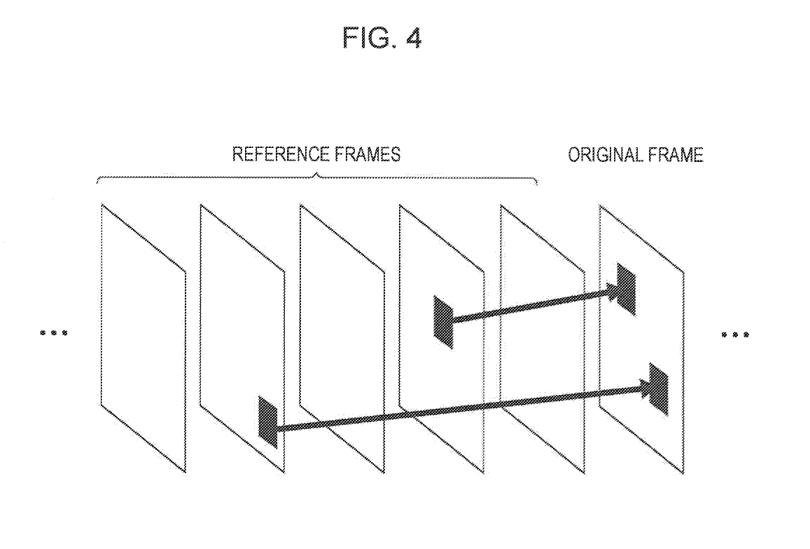

The multi-reference frame (Multi-Reference Frame) stipulated with AVC will be described with reference to FIG. 4.

That is to say, with MPEG-2 and H.263, in the case of a P picture, motion prediction/compensation processing has been performed by referencing just one reference frame stored in frame memory, but with AVC, as shown in FIG. 4, multiple reference frames are stored in memory, and different memory can be referenced for each macroblock.

Now, though the information amount of the motion vector information regarding B pictures is vast, with AVC, a mode referred to as Direct Mode (direct mode) is prepared.

In the direct mode (Direct Mode), motion vector information is not stored in image compression information. At the image decoding device, the motion vector information of the current block is calculated from motion vector information of surrounding blocks, or motion vector information of a co-located block that is a block at the same position as the block to be processed in the reference frame.

The direct mode (Direct Mode) includes two types, a Spatial Direct Mode (spatial direct mode) and a Temporal Direct Mode (temporal direct mode), and can be switched for each slice.

With the spatial direct mode (Spatial Direct Mode), motion vector information mv_{E} as to the compensation block E to be processed is calculated, as the following Expression (12)

mv_{E}=pmv_{E} (12)

That is to say, the prediction motion vector information generated by Median (median) prediction is applied as the motion vector information of the current block.

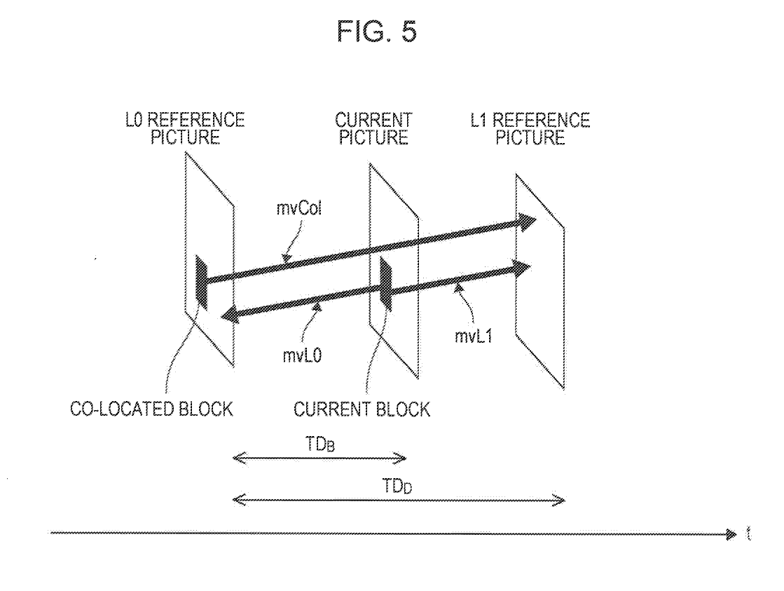

In the following, the temporal direct mode (Temporal Direct Mode) will be described with reference to FIG. 5

In FIG. 5, with the L0 reference picture, a block at the same spatial address as the current block will be called a Co-Located block, and let us say that motion vector information in the Co-Located block is mv_{col}. Also, let us say that distance on the temporal axis between the current picture and L0 reference picture is TD_{B}, and distance on the temporal axis between the L0 reference picture and L1 reference picture is TD_{D}.

At this time, the L0 motion vector information mv_{L0} and the L1 motion vector information mv_{L1} in the current picture can be calculated with the following Expression (13) and Expression (14)

$$\begin{matrix}[ Mathematical Expression 12 ] & \\ {mv}_{L 0} = \frac{{TD}_{B}}{{TD}_{D}} {mv}_{col} & ( 13 ) \\ [ Mathematical Expression 13 ] & \\ {mv}_{L 1} = \frac{{TD}_{D} - {TD}_{B}}{{TD}_{D}} {mv}_{col} & ( 14 )\end{matrix}$$

Note that, with AVC image compression information, there is no information TD representing distance on the temporal axis, so POC (Picture Order Count) is employed to perform the computation of the above-described Expression (12) and Expression (13).

Also, with AVC image compression information, the direct mode (Direct Mode) can be defined in increments of 16×16 pixel macroblocks, or in increments of 8×8 pixel blocks.

### [Selection of Prediction Mode]

Now, with the AVC encoding format, in order to achieve higher encoding efficiency, selection of a suitable prediction mode is important.

As for an example of the selection method, a method implemented in reference software for H.264/MPEG-4 AVC called JM (Join Model) (disclosed at http://iphome.hhi.de/suehring/tml/index.htm) can be given.

With JM, selection can be made from the two mode determination methods of High Complexity Mode and Low Complexity Mode described below. With both, a cost function value is calculated relating to the respective prediction modes, and the prediction mode which yields the smallest thereof is selected as the optimal mode as to the current sub macroblock or current macroblock.

In the High Complexity Mode, the cost function is represented as with the following Expression (15)

Cost(ModeεΩ)=D+λ×R (15)

Here, Ω is the whole set of candidate modes for encoding the current block through macroblock, D is difference energy between the decoded image and input image in the case of encoding with the current prediction mode. λ is a Lagrange multiplier given as a function of a quantization parameter. R is the total code amount in the case of encoding with the current mode, including orthogonal transform coefficients.

That is to say, in order to perform encoding with the High Complexity Mode, there is the need to perform tentative encoding processing once by all candidate modes in order to calculate the above parameters D and R, requiring a greater amount of computations.

The cost function in the Low Complexity Mode is represented as shown in the following Expression (16).

Cost(ModeεΩ)=D+QP2Quant(QP)×HeaderBit (16)

Here, D is the difference energy between the prediction image and input image, unlike the case of the High Complexity Mode. QP2Quant (QP) is given as a function of a quantization parameter QP, and HeaderBit is the code amount relating to information belonging to the Header not including orthogonal transform coefficients, such as motion vectors and mode.

That is to say, in the Low Complexity Mode, prediction processing needs to be performed relating to each candidate mode, but there is no need to perform all the way to a decoded image, so there is no need to perform all the way to decoding processing. Accordingly, realization with a smaller amount of computation as compared to the High Complexity Mode is enabled.

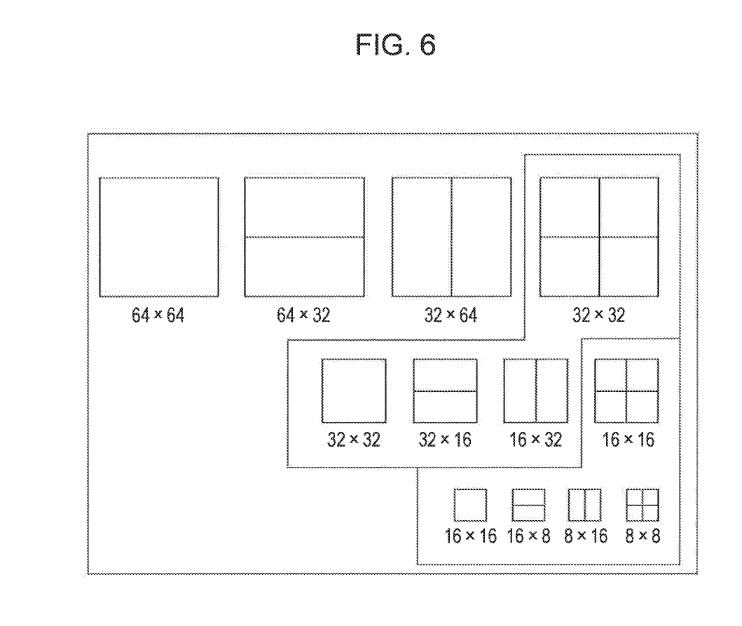

Now, the macroblock size OF 16×16 pixels is not optimal for large image frames such as UHD (Ultra High Definition; 4000×2000 pixels) which will be handled by next-generation encoding methods. Accordingly, NPL 1 and so forth propose enlarging the macroblock size to a size of 64×64 pixels, 32×32 pixels, and so on, as shown in FIG. 6.

That is to say, with NPL 1, by employing a hierarchical structure as in FIG. 6, blocks of 16×16 pixels and smaller maintain compatibility with macroblocks in the current AVC, while larger blocks are defined as supersets thereof.

Now, with the AVC encoding method, a skip mode is also provided as a mode where sending motion vector information in the same way as with the direct mode is not necessary. The skip mode and direct mode do not have to transmit motion vector information, and in particular, by being applied to wider regions, contribute to improved encoding efficiency.

however, with the technique proposed in NPL 1, the skip mode and direct mode is only applied to square blocks of the blocks which are motion partitions, so there has been the concern that encoding efficiency might not improve.

Accordingly, the skip mode and direct mode will be made applicable for rectangular blocks as well, such that encoding efficiency can be improved.

### [Image Encoding Device]

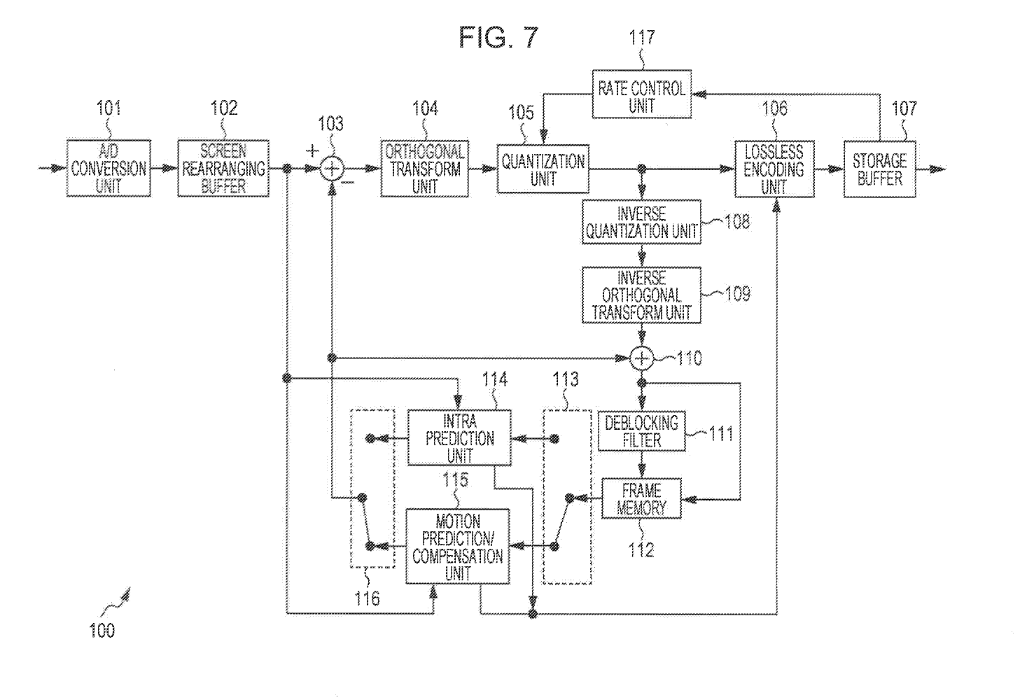

FIG. 7 represents the configuration of an embodiment of an image encoding device serving as an image processing device.

An image encoding device 100 shown in FIG. 7 is an encoding device which subjects an image to encoding using, for example, the H.264 and MPEG (Moving Picture Experts Group) 4 Part 10 (AVC (Advanced Video Coding)) (hereafter, called H.264/AVC) format. Note however, that the image encoding device 100 applies the skip mode and direct mode to not only square blocks but also to rectangular blocks. Accordingly, the image encoding device 100 can improve encoding efficiency.

With the example in FIG. 7, the image encoding device 100 has an A/D (Analog/Digital) conversion unit 101, a screen rearranging buffer 102, a computing unit 103, an orthogonal transform unit 104, a quantization unit 105, a lossless encoding unit 106, and a storage buffer 107. The image encoding device 100 also has an inverse quantization unit 108, an inverse orthogonal transform unit 109, and a computing unit 110 a deblocking filter 111, frame memory 112, a selecting unit 113, an intra prediction unit 114, a motion prediction/compensation unit 115, a selecting unit 116, and a rate control unit 117.

The A/D conversion unit 101 performs A/D conversion of input image data, and outputs to the screen rearranging buffer 102 and stores.

The screen rearranging buffer 102 rearranges the images of frames in the stored order for display into the order of frames for encoding according to GOP (Group of Picture) structure. The screen rearranging buffer 102 supplies the images of which the frame order has been rearranged to the computing unit 103. The screen rearranging buffer 102 also supplies the images of which the frame order has been rearranged to the intra prediction unit 114 and motion prediction/compensation unit 115.

The computing unit 103 subtracts, from the image read out from the screen rearranging buffer 102, the prediction image supplied from the intra prediction unit 114 or motion prediction/compensation unit 115 via the selecting unit 116, and outputs difference information thereof to the orthogonal transform unit 104.

For example, in the event of an image regarding which inter encoding is to be performed, the computing unit 103 subtracts the prediction image supplied from the intra prediction unit 114 from the image read out from the screen rearranging buffer 102. Also, for example, in the case of an image regarding which inter encoding is to be performed, the computing unit 103 subtracts the prediction image supplied from the motion prediction/compensation unit 115 from the image read out from the screen rearranging buffer 102.

The orthogonal transform unit 104 subjects the difference information from the computing unit 103 to orthogonal transform, such as discrete cosine transform, Karhunen-Loéve transform, or the like, and supplies a transform coefficient thereof to the quantization unit 105.

The quantization unit 105 quantizes the transform coefficient that the orthogonal transform unit 104 outputs. The quantization unit 105 sets a quantization parameter based on information supplied from the rage control unit 117, and quantizes. The quantization unit 105 supplies the quantized transform coefficient to the lossless encoding unit 106.

The lossless encoding unit 106 subjects the quantized transform coefficient to lossless encoding, such as variable length coding, arithmetic coding, or the like.

The lossless encoding unit 106 obtains information indicating intra prediction and so forth from the intra prediction unit 114, and obtains motion vector information indicating inter prediction mode and so forth from the motion prediction/compensation unit 115. Note that the information indicating intra prediction (intra-screen prediction) will also be referred to as intra prediction mode information hereinafter. Also, the information indicating information mode indicating inter prediction (inter-screen prediction) will also be referred to as inter prediction mode information hereinafter.

The lossless encoding unit 106 encodes the quantized transform coefficient, and also takes filter coefficients, intra prediction mode information, inter prediction mode information, quantization parameters, and so forth, as part of header information in the encoded data (multiplexes). The lossless encoding unit 106 supplies the encoded data obtained by encoding to the storing buffer 107 for storage.

For example, with the lossless encoding unit 106, lossless encoding processing, such as variable length coding, arithmetic coding, or the like, is performed. Examples of the variable length coding include CAVLC (Context-Adaptive Variable Length Coding) stipulated by the H.264/AVC format. Examples of the arithmetic coding include CABAC (Context-Adaptive Binary Arithmetic Coding).

The storage buffer 107 temporarily holds the encoded data supplied from the lossless encoding unit 106, and at a predetermined timing outputs this to, for example, a recording device or transmission path or the like downstream not shown in the drawing, as an encoded image encoded by the H.264/AVC format.

Also, the quantized transform coefficient output from the quantization unit 105 is also supplied to the inverse quantization unit 108. The inverse quantization unit 108 performs inverse quantization of the quantized transform coefficient with a method corresponding to quantization at the quantization unit 105. The inverse quantization unit 108 supplies the obtained transform coefficient to the inverse orthogonal transform unit 109.

The inverse orthogonal transform unit 109 performs inverse orthogonal transform of the supplied transform coefficients with a method corresponding to the orthogonal transform processing by the orthogonal transform unit 104. The output subjected to inverse orthogonal transform (restored difference information) is supplied to the computing unit 110.

The computing unit 110 adds the inverse orthogonal transform result supplied from the inverse orthogonal transform unit 109, i.e., the restored difference information, to the prediction image supplied from the intra prediction unit 114 or the motion prediction/compensation unit 115 via the selecting unit 116, and obtains a locally decoded image (decoded image).

In the event that the difference information corresponds to an image regarding which intra encoding is to be performed, for example, the computing unit 110 adds the prediction image supplied from the intra prediction unit 114 to that difference information. Also, in the event that the difference information corresponds to an image regarding which inter encoding is to be performed, for example, the computing unit 110 adds the prediction image supplied from the motion prediction/compensation unit 115 to that difference information.

The addition results thereof are supplied to the deblocking filter 111 or frame memory 112.

The deblocking filter 111 removes block noise from the decoded image by performing deblocking filter processing as appropriate, and also performs image quality improvement by performing loop filter processing as appropriate using a Wiener filter (Wiener Filter), for example. The deblocking filter 111 performs class classification of each of the pixels, and performs appropriate filter processing for each class. The deblocking filter 111 then supplies the filter processing results to the frame memory 112.

The frame memory 112 outputs the stored reference image to the intra prediction unit 114 or the motion prediction/compensation unit 115 via the selecting unit 113 at a predetermined timing.

For example, in the case of an image regarding which intra encoding is to be performed, for example, the frame memory 112 supplies the reference image to the intra prediction unit 114 via the selecting unit 113. Also, in the case of an image regarding which inter encoding is to be performed, for example, the frame memory 112 supplies the reference image to the motion prediction/compensation unit 115 via the selecting unit 113.

The selecting unit 113 supplies the reference image supplied from the frame memory 112 to the intra prediction unit 114 in the case of an image regarding which intra encoding is to be performed. Also, the selecting unit 113 supplies the reference image to the motion prediction/compensation unit 115 in the case of an image regarding which inter encoding is to be performed.

The intra prediction unit 114 performs intra prediction to generate a prediction image using pixel values within the screen (intra screen prediction). The intra prediction unit 114 performs intra prediction by multiple modes (intra prediction modes).

The intra prediction unit 114 generates prediction images in all intra prediction modes, evaluates the prediction images, and selects an optimal mode. Upon selecting an optimal intra prediction mode, the intra prediction unit 114 supplies the prediction image generated in that optimal mode to the computing unit 103 and computing unit 110 via the selecting unit 116.

Also, as described above, the intra prediction unit 114 supplies information such as intra prediction mode information indicating the intra prediction mode employed, and so forth, to the lossless encoding unit 106 as appropriate.

With regard to the image to be subjected to inter encoding, the motion prediction/compensation unit 115 uses the input image supplied from the screen rearranging buffer 102 and decoded image serving as the reference image supplied from the frame memory 112 via the selecting unit 113, to perform motion compensation processing according to the detected motion vector, and generate a prediction image (inter prediction image information).

The motion prediction/compensation unit 115 performs inter prediction processing for all candidate inter prediction modes, and generates prediction images. At this time, the motion prediction/compensation unit 115 applies the skip mode and direct mode even in cases of taking rectangular sub macroblocks as motion partitions in extended macroblocks greater than 16×16 pixels, as proposed in NPL 1, for example. The motion prediction/compensation unit 115 calculates cost function values for each mode, including such skip mode and direct mode in the candidates as well, and selects an optimal mode.

The motion prediction/compensation unit 115 supplies the generated prediction image to the computing unit 103 and computing unit 110 via the selecting unit 116.

The motion prediction/compensation unit 115 also supplies inter prediction mode information indicating the inter prediction mode that has been employed, and the motion vector information indicating the calculated motion vector, to the lossless encoding unit 106.

While described in detail later, in a case of taking rectangular sub macroblocks as motion partitions in extended macroblocks, the motion prediction/compensation unit 115 generates a flag called block_skip_direct_flag, which indicates whether the skip mode or direct mode. The motion prediction/compensation unit 115 calculates the cost function including this flag as well. Note that in the event that a mode with a rectangular block is taken as a motion partition as the result of the mode selection based on cost functions, the motion prediction/compensation unit 115 supplies this block_skip_direct_flag to the lossless encoding unit 106 to be encoded, and transmits to the decoding side.

The selecting unit 116 supplies the output of the intra prediction unit 114 to the computing unit 103 and computing unit 110 in the case of an image for performing intra encoding, and supplies the output of the motion prediction/compensation unit 115 to the computing unit 103 and computing unit 110 in the case of an image for performing inter encoding.

The rate control unit 117 controls the rate of quantization operations of the quantization unit 105 based on the compressed image stored in the storage buffer 107, such that overflow or underflow does not occur.

### [Motion Prediction/Compensation Unit]

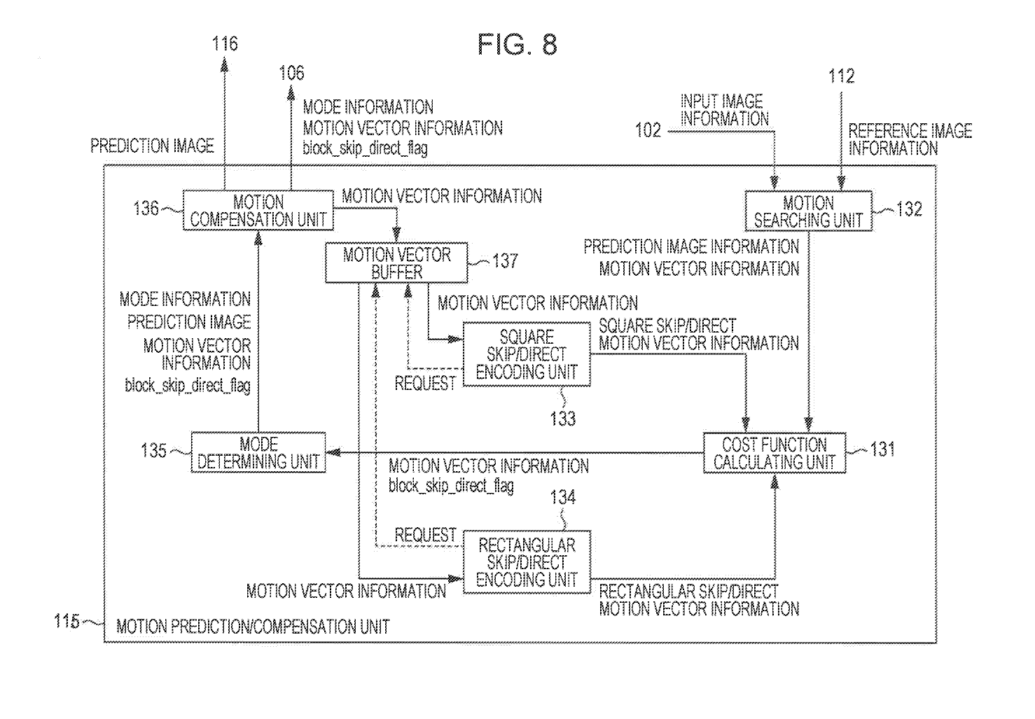

FIG. 8 is a block diagram illustrating a detailed configuration example of the motion prediction/compensation unit 115 in FIG. 7.

As shown in FIG. 8, the motion prediction/compensation unit 115 includes a cost function calculating unit 131, a motion searching unit 132, a square skip/direct encoding unit 133, a rectangular skip/direct encoding unit 134, a mode determining unit 135, a motion compensation unit 136, and a motion vector buffer 137.

The cost function calculating unit 131 calculates cost functions in each inter prediction mode (for all candidate modes). While the calculation method of cost functions is optional, this may be performed in the same way as with the above-described AVC encoding format, for example.

For example, the cost function calculating unit 131 obtains motion vector information and prediction image information regarding each mode which the motion searching unit 132 has generated, and calculates cost functions. The motion searching unit 132 generates motion vector information and prediction image information regarding each candidate mode (each intra prediction mode for each motion partition), using input image information obtained from the screen rearranging buffer 102, and the reference image information obtained from the frame memory 112.

The motion searching unit 132 generates motion vector information and prediction image information regarding not only macroblocks of 16×16 pixels stipulated in the AVC encoding format and so forth (hereinafter called normal macroblocks), but also macroblocks of sizes greater than 16×16 pixels, such as proposed in NPL 1 and so forth (hereinafter referred to as extended macroblocks). Note however, that the motion searching unit 132 does not perform processing regarding the skip mode and direct mode.

The cost function calculating unit 131 calculates cost functions for each candidate mode, using the motion vector information and prediction image information supplied from the motion searching unit 132. Note that in the case of a mode where rectangular sub macroblocks of extended macroblocks are to be taken as motion partitions, the cost function calculating unit 131 generates a block_skip_direct_flag which indicates whether the mode is a skip mode or a direct mode.

As described above, the motion searching unit 132 does not perform processing regarding the skip mode and direct mode. That is to say, in this case, the cost function calculating unit 131 sets the value of the block_skip_direct_flag to 0. Note that the cost function calculating unit 131 calculates the cost functions including this block_skip_direct_flag.

Also, the cost function calculating unit 131 obtains rectangular skip/direct motion vector information which is motion vector information regarding the skip mode and direct mode, generated by the square skip/direct encoding unit 133, and calculates cost functions.

The square skip/direct encoding unit 133 takes normal macroblocks or sub macroblocks thereof, or extended macroblocks or square sub macroblocks of the sub macroblocks thereof, as motion partitions (hereinafter referred to as square motion partitions), and generates motion vector information in the skip mode or direct mode.

In the case of the skip mode or direct mode, motion vectors are generated using motion vectors of surrounding blocks already generated. The square skip/direct encoding unit 133 requests the motion vector buffer 137 for vector information surrounding blocks that is necessary, obtains this. The square skip/direct encoding unit 133 supplies square skip/direct motion vector information generated in this way to the cost function calculating unit 131.

Further, the cost function calculating unit 131 obtains rectangular skip/direct motion vector information which is motion vector information regarding the skip mode and direct mode, generated by the rectangular skip/direct encoding unit 134, and calculates cost functions.

The rectangular skip/direct encoding unit 134 takes rectangular sub macroblocks of the sub macroblocks of extended macroblocks as motion partitions (hereinafter referred to as rectangular motion partitions), and generates motion vector information in the skip mode or direct mode.

In the same way as with square, in the case of the skip mode or direct mode, motion vectors are generated using motion vectors of surrounding blocks already generated. The rectangular skip/direct encoding unit 134 requests the motion vector buffer 137 for vector information surrounding blocks that is necessary, obtains this. The way in which motion vectors are obtained in the skip mode and direct mode is basically the same for both rectangular motion partitions and square motion partitions. Note however, that the position of surrounding blocks to reference differs depending on the shape.

The rectangular skip/direct encoding unit 134 supplies the rectangular skip/direct motion vector information generated in this way to the cost function calculating unit 131.

In this case, the cost function calculating unit 131 generates a block_skip_direct_flag as described above, sets the value thereof to 1, and calculates cost functions including the block_skip_direct_flag.

The cost function calculating unit 131 supplies the calculated cost function values of each candidate mode to the mode determining unit 135, along with the prediction image, motion vector information, and block_skip_direct_flag and so forth.

The mode determining unit 135 determines the mode of the candidate modes of which the cost function value is smallest, to be the optimal intra prediction mode, and notifies the motion compensation unit 136 thereof. The mode determining unit 135 supplies the motion compensation unit 136 with the mode information of the selected candidate mode, and also with the prediction image of that mode, motion vector information, and block_skip_direct_flag and so forth, as necessary.

The motion compensation unit 136 supplies a prediction image of the mode selected as the optional intra prediction mode, to the selecting unit 116. Also, in the event that the intra prediction mode has been selected by the selecting unit 116, the motion compensation unit 136 supplies the lossless encoding unit 106 with necessary information such as mode information of that mode, motion vector information, and block_skip_direct_flag and so forth.

Also, the motion compensation unit 136 supplies motion vector information of the mode selected as the optimal intra prediction mode to the motion vector buffer 137, so as to be held. The motion vector information held in the motion vector buffer 137 is referenced as motion vector information of surrounding blocks, in processing regarding motion partitions performed subsequently.

Since there is no need to transmit motion vector information, the greater a region the skip mode and direct mode are applied to, the more greatly they contribute to improved encoding efficiency. In recent years, higher resolution of images is advancing, and accordingly, even greater regions such as the extended macroblocks proposed in NPL 1. That is to say, enabling skip mode and direct mode to be applied to such extended macroblocks is desirable for improvement in encoding efficiency.

However, the greater the region is, the greater the number of types of elements included in a single region is, and also the greater the probability is that there will be elements unsuitable for the skip mode and direct mode included. With a conventional format such as the AVC encoding format and so forth, with the skip mode and direct mode, only stipulations are made of square motion partitions, so in the event that an image unsuitable for the skip mode or direct mode is included in a part of an extended macroblock, even if the other portions are images suitable for the skip mode or direct mode, the skip mode or direct mode is not selected, or had to be divided into unnecessarily small partitions. Either way, there has been the concern that the degree of contribution to improved encoding efficiency would suffer.

Conversely, the motion prediction/compensation unit 115 applies the skip mode or direct mode to rectangular motion partitions as well, by way of the rectangular skip/direct encoding unit 134, calculates motion vector information as one candidate mode, and evaluates cost functions.

Thus, the motion prediction/compensation unit 115 can apply the skip mode or direct mode to greater regions, and can improve encoding efficiency.

### [Cost Function Calculating Unit]

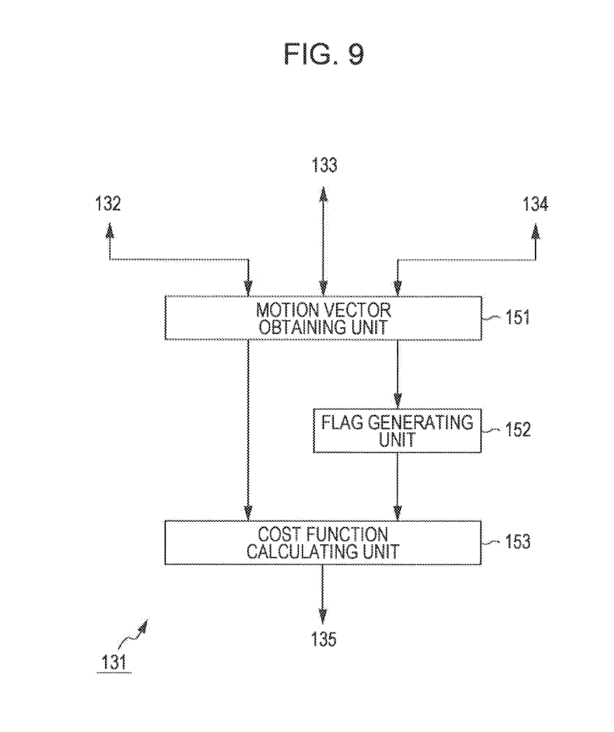

FIG. 9 is a block diagram illustrating a primary configuration of the cost function calculating unit 131 in FIG. 8.

As shown in FIG. 9, the cost function calculating unit 131 has a motion vector obtaining unit 151, a flag generating unit 152, and a cost function calculating unit 153.

The motion vector obtaining unit 151 obtains motion vector information and so forth regarding each candidate mode, from each of the motion searching unit 132, square skip/direct encoding unit 133, and rectangular skip/direct encoding unit 134. The motion vector obtaining unit 151 supplies the obtained information to the cost function calculating unit 153.

Note however, in the event of having obtained motion vector information from the motion searching unit 132 or the rectangular skip/direct encoding unit 134, the motion vector obtaining unit 151 notifies the flag generating unit 152 to that effect, and generates a block_skip_direct_flag.

The flag generating unit 152 generates a block_skip_direct_flag regarding a mode in which a rectangular sub macroblock of a extended macroblock is taken as a motion partition. The flag generating unit 152 sets the value of the block_skip_direct_flag to 1 in the event of skip mode or direct mode, and otherwise sets the block_skip_direct_flag to 0. The flag generating unit 152 supplies the generated block_skip_direct_flag to the cost function calculating unit 153.

Based on the information supplied from the motion vector obtaining unit 151, the cost function calculating unit 153 calculates cost functions for the candidate modes. In the event of being supplied with a block_skip_direct_flag from the flag generating unit 152, cost functions are calculated including that block_skip_direct_flag.

The cost function calculating unit 153 supplies the calculated cost function values and other information to the mode determining unit 135.

With NPL 1, 0 or 1, 2, 3, or 8 is allocated to each code_number of the respective 64×64 motion partitions at the first hierarchical level of the extended macroblock shown in FIG. 7, 64×32 motion partitions, 32×64 motion partitions, and 32×32 motion partitions. For the 64×64 motion partitions, the code_number is 0 in the event of encoding in skip mode or direct mode, and otherwise the code_number is 1.

Conversely, for 64×32 motion partitions and 32×64 motion partitions, the flag generating unit 152 generates a block_skip_direct_flag and adds to syntax elements. In the event of these motion partitions are to be encoded in skip mode or direct mode, the flag generating unit 152 sets the value of the block_skip_direct_flag to 1. At this time, if a P-slice, the rectangular motion compensation partition has no motion vector information nor orthogonal transform coefficients, so the mode is the skip mode, and also if a B-slice, no motion vector information is had an encoding is performed as the direct mode.

Note that block_skip_direct_flag may be used with rectangular motion partitions in the first hierarchical level and second hierarchical level shown in FIG. 7.

By enabling such encoding processing skip mode and direct mode with rectangular motion partitions, which has been impossible to use with NPL 1, can be used with extended size blocks, and higher encoding efficiency can be realized.

Note that while skip mode and direct mode may be instructed as a part of mode information, focusing on the 64×32 motion partition in FIG. 8 for example, the mode representation with a single code_number has to be expressed with four code_number, for a case of both upper and lower motion partitions being skip mode or direct mode, a case of just the upper motion partition being skip mode or direct mode, a case of just the lower motion partition being skip mode or direct mode, and a case of neither upper nor lower motion partitions being skip mode or direct mode, so there is a concern that this will lead to increased number of bits in the output image compression information.

As described above, the motion prediction/compensation unit 115 generates the block_skip_direct_flag indicating whether the skip mode or direct mode, separately from the mode information, and this is transmitted to the decoding side, so such unnecessary increase of bit amount can be suppressed, and encoding efficiency can be improved.

### [Rectangular Skip/Direct Encoding Unit]

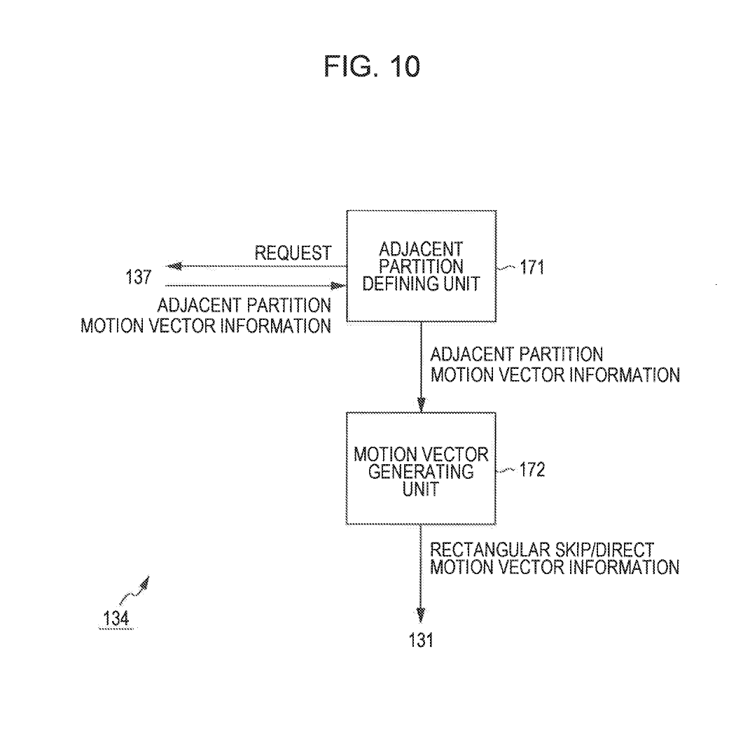

FIG. 10 is a block diagram illustrating a primary configuration example of the rectangular skip/direct encoding unit 134 in FIG. 8.

As shown in FIG. 10, the rectangular skip/direct encoding unit 134 has an adjacent partition defining unit 171 and a motion vector generating unit 172.

The adjacent partition defining unit 171 decides a motion partition regarding which to generate a motion vector, and defines an adjacent partition adjacent to that motion partition.

As described above, in the skip mode and direct mode, motion vectors of surrounding blocks (adjacent partitions) are necessary for generating motion vectors. In the event that the motion partition is a rectangle, the adjacent blocks differ depending on the position and shape thereof.

The adjacent partition defining unit 171 supplies information relating to the position and shape of the motion partition to be processed, to the motion vector buffer 137, and requests motion vector information regarding the adjacent partition.

The motion vector buffer 137 supplies motion vector information of the adjacent partition adjacent to the motion partition to be processed, to the adjacent partition defining unit 171, based on the position and shape of the motion partition to be processed.

Upon obtaining adjacent partition motion vector information from the motion vector buffer 137, the adjacent partition defining unit 171 supplies the adjacent partition motion vector information, and information relating to the position and shape of the motion partition to be processed, to the motion vector generating unit 172.

The motion vector generating unit 172 generates a motion vector for the motion partition to be processed, based on the various types of information supplied from the adjacent partition defining unit 171. The motion vector generating unit 172 supplies the generated motion vector information (rectangular skip/direct motion vector information) to the cost function calculating unit 131.

As described above, the adjacent partition defining unit 171 obtains correct adjacent partition motion vector information from the motion vector buffer 137 in accordance with the shape of the motion partitions, so the rectangular skip/direct encoding unit 134 can generate correct motion vector information.

### [Flow of Encoding Processing]

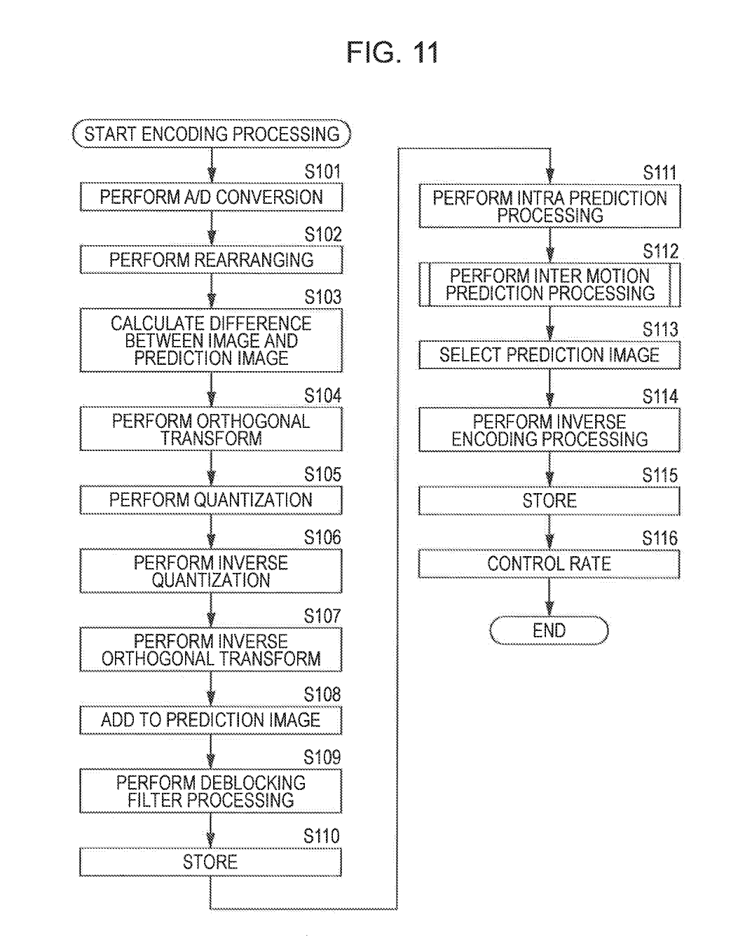

Next, the flow of each processing executed by the image encoding device 100 as described above will be described. First, an example of the flow of encoding processing will be described with reference to the flowchart in FIG. 11.

In step S101, the A/D conversion unit 101 performs A/D conversion of the input image. In step S102, the screen rearranging buffer 102 stores the A/D-converted image, and performs rearranging from the order of display the pictures to the order for encoding.

In step S103, the computing unit 103 computes the difference between the images rearranged by the processing in step S102, and a prediction image. The prediction image is input via the selecting unit 116, from the motion prediction/compensation unit 115 in the event of performing inter prediction, and from the intra prediction unit 114 in the event of performing intra prediction, and is supplied to the computing unit 103.

The amount of data is smaller for difference data, as compared to the original image data. Accordingly, the data amount can be compressed as compared to the case of encoding the original image without change.

In step S104, the orthogonal transform unit 104 subjects the difference information supplied generated by the processing in step S103 to orthogonal transform. Specifically, orthogonal transform, such as discrete cosine transform, Karhunen-Loéve transform, or the like, is performed, and a transform coefficient is output.

In step S105, the quantization unit 105 quantizes the orthogonal transform coefficient obtained by the processing in step S104.

The difference information quantized by the processing in step S105 is locally decoded as follows. That is to say, in step S106, the inverse quantization unit 108 subjects the orthogonal transform coefficient quantized by the processing in step S105 (also called quantized coefficient) to inverse quantization using a property corresponding to the property of the quantization unit 105. In step S107, the inverse orthogonal transform unit 109 subjects the orthogonal transform coefficient obtained by the processing in step S106 to inverse orthogonal transform using a property corresponding to the property of the orthogonal transform unit 104.

In step S108, the computing unit 110 adds the prediction image to the locally decoded difference information, and generates a locally decoded image (the image corresponding to the input to the computing unit 103). In step S109, the deblocking filter 111 subjects the image generated by the processing in step S108 to filtering. Thus, block distortion is removed.

In step S110, the frame memory 112 stores the image subjected to block distortion removal by the processing in step S109. Note that an image not subjected to filtering processing by the deblocking filter 111 is also supplied from the computing unit 110 to the frame memory 112 for storing.

In step S111, the intra prediction unit 114 performs intra prediction mode intra prediction processing. In step S112, the motion prediction/compensation unit 115 performs inter prediction processing where motion prediction and motion compensation are performed in the inter prediction mode.

In step S113, the selecting unit 116 decides the optimal prediction mode based on the cost function values output from the intra prediction unit 114 and motion prediction/compensation unit 115. That is to say, the selecting unit 116 selects one or the other of the prediction image generated by the intra prediction unit 114 and the prediction image generated by the motion prediction/compensation unit 115.

Also, the selection information of which prediction image has been selected is supplied to the one of the intra prediction unit 114 or motion prediction/compensation unit 115 of which the prediction image has been selected. In the event that the prediction image of the optimal intra prediction mode has been selected, the intra prediction unit 114 supplies information indicating the optimal intra prediction mode (i.e., intra prediction mode information) to the lossless encoding unit 106.

In the event that the prediction image of the optimal inter prediction mode has been selected, the motion prediction/compensation unit 115 outputs information indicating the optimal inter prediction mode, and information according to the optimal inter prediction mode as necessary, to the lossless encoding unit 106. Examples of information according to the optimal inter prediction mode include motion vector information, flag information, reference frame information, and so forth.

In step S114, the lossless encoding unit 106 encodes the quantized transform coefficient quantized by the processing in step S105. That is to say, the difference image (secondary difference image in the case of inter) is subjected to lossless encoding such as variable-length encoding, arithmetic encoding, or the like.

Note that the lossless encoding unit 106 encodes the quantized parameter calculated in step S105, and adds to the encoded data.

Also, the lossless encoding unit 106 encodes information relating to the prediction mode of the prediction image selected by the processing in step S113, and adds to the encoded data obtained by encoding the difference image. That is to say, the lossless encoding unit 106 also encodes intra prediction mode information supplied from the intra prediction unit 114 or information according to the optimal inter prediction mode supplied from the motion prediction/compensation unit 115 and so forth, and adds this to the encoded data.

In step S115, the storage buffer 107 stores encoded data output from the lossless encoding unit 106. The encoded data stored in the storage buffer 107 is read out as suitable, and transmitted to the decoding side via the transmission path.

In step S116, the rate control unit 117 controls the rate of the quantization operation of the quantization unit 105, based on the compressed image stored in the storage buffer 107 by the processing in step S115, so as not to cause overflow or underflow.

Upon the processing of step S116 ending, the encoding processing ends.

### [Flow of Inter Motion Prediction Processing]

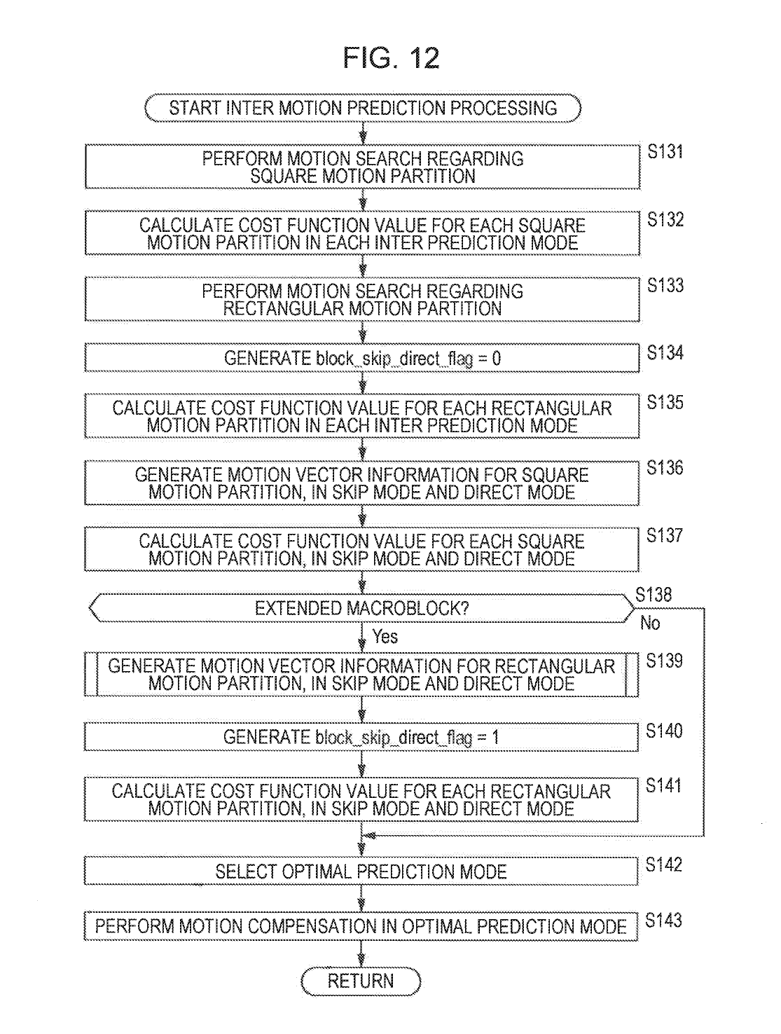

Next, an example of the flow of inter motion prediction processing executed in step S112 in FIG. 11 will be described with reference to the flowchart in FIG. 12.

Upon inter motion prediction processing being started, in step S131 the motion searching unit 132 performs motion searching for, of each of the modes for square motion partitions, modes other than skip mode and direct mode, and generates motion vector information.

Upon the motion vector obtaining unit 151 of the cost function calculating unit 131 obtaining the motion vector information, in step S132 the cost function calculating unit 153 calculates cost functions for each mode for the square motion partition, excluding the skip mode and direct mode. In step S133, the motion searching unit 132 performs motion searching of each of the modes for rectangular motion partitions, excluding skip mode and direct mode, and generates motion vector information.

Upon the motion vector obtaining unit 151 of the cost function calculating unit 131 obtaining the motion vector information, in step S134 the flag generating unit 152 generates a block_skip_direct_flag with the value 0 (block_skip_direct_flag=0). In step S135, the cost function calculating unit 153 calculates cost functions including the flag value.

In step S136, the square skip/direct encoding unit 133 generates motion vector information regarding the square motion partition in skip mode and direct mode.

Upon the motion vector obtaining unit 151 of the cost function calculating unit 131 obtaining the motion vector information, in step S137 the cost function calculating unit 153 calculates cost functions for the square motion partition in the skip mode and direct mode.

In step S138, the cost function calculating unit 131 determines whether or not the macroblock to be processed is an extended macroblock, and in the event that determination is made that this is an extended macroblock, the flow advances to step S139.

In step S139, the rectangular skip/direct encoding unit 134 generates motion vector information for a rectangular motion partition in skip mode and direct mode.

Upon the motion vector obtaining unit 151 of the cost function calculating unit 131 obtaining the motion vector information, in step S140 the flag generating unit 152 generates a block_skip_direct_flag with a value 1 (block_skip_direct_flag=1). In step S141, the cost function calculating unit 153 calculates cost functions including the flag value.

Upon the processing of step S141 ending, the cost function calculating unit 131 provides the cost function values and so forth to the mode determining unit 135, and advances the flow to step S142. Also, in the event that determination is made in step S138 that the object of processing is not an extended macroblock, the cost function calculating unit 131 omits the processing of step S139 through step S141, provides the cost function values and so forth to the mode determining unit 135, and advances the flow to step S142.

In step S142, the mode determining unit 135 selects an optimal inter prediction mode based on the calculated cost function values in each mode. In step S143, the motion compensation unit 136 performs motion compensation in the selected mode (optimal inter prediction mode). Also, the motion compensation unit 136 holds the motion vector information of the selected mode in the motion vector buffer 137, ends the inter motion prediction processing, returns the flow to step S112 in FIG. 11, and causes the subsequent processing to be executed.

### [Flow of Rectangular Skip/Direct Motion Vector Information Generating Processing]

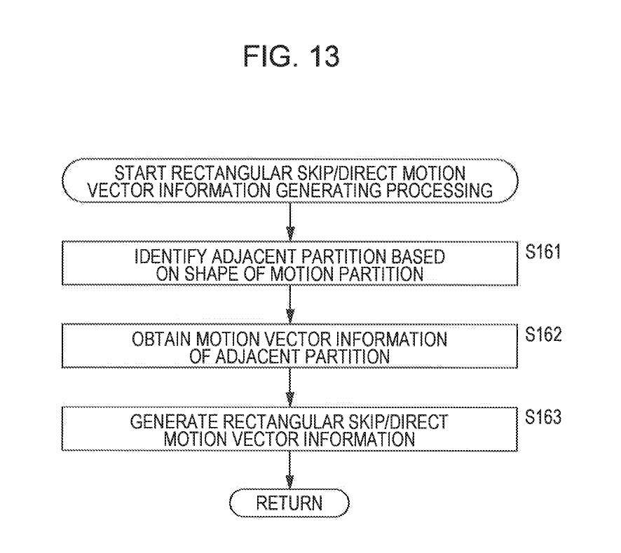

Next, an example of the flow of rectangular skip/direct motion vector information generating processing, executed in step S139 in FIG. 12, will be described with reference to the flowchart in FIG. 13.

Upon rectangular skip/direct motion vector information generating processing being started, the adjacent partition defining unit 171 of the rectangular skip/direct encoding unit 134 identifies adjacent partitions in step S161 cooperatively with the motion vector buffer 137, and obtains the motion vector information thereof in step S162.

In step S163, the motion vector generating unit 172 uses the motion vectors obtained in step S162 to generate motion vector information in the skin mode or direct mode (rectangular skip/direct motion vector information). Upon the processing of step S163 ending, the rectangular skip/direct encoding unit 134 ends the rectangular skip/direct motion vector information generating processing, returns the flow to step S139 in FIG. 12, and causes the subsequent processing to be executed.

Thus, the image encoding device 100 takes rectangular sub macroblocks of extended macroblocks as motion partitions, as one of the intra prediction modes, and performs motion prediction/compensation in the skip mode and direct mode at the motion prediction/compensation unit 115.

Accordingly, the skip mode and direct mode can be applied to greater regions, and encoding efficiency can be improved.

Also, in the event of taking rectangular sub macroblocks of extended macroblocks as motion partitions in this way, the image encoding device 100 generates a block_skip_direct_flag indicating whether skip mode or direct mode, separately from code_number, and supplies this to the decoding side of the code stream.

Thus, reduction of encoding efficiency due to increased bits of the code_number can be suppressed.

### 2. Second Embodiment

### [Image Decoding Device]

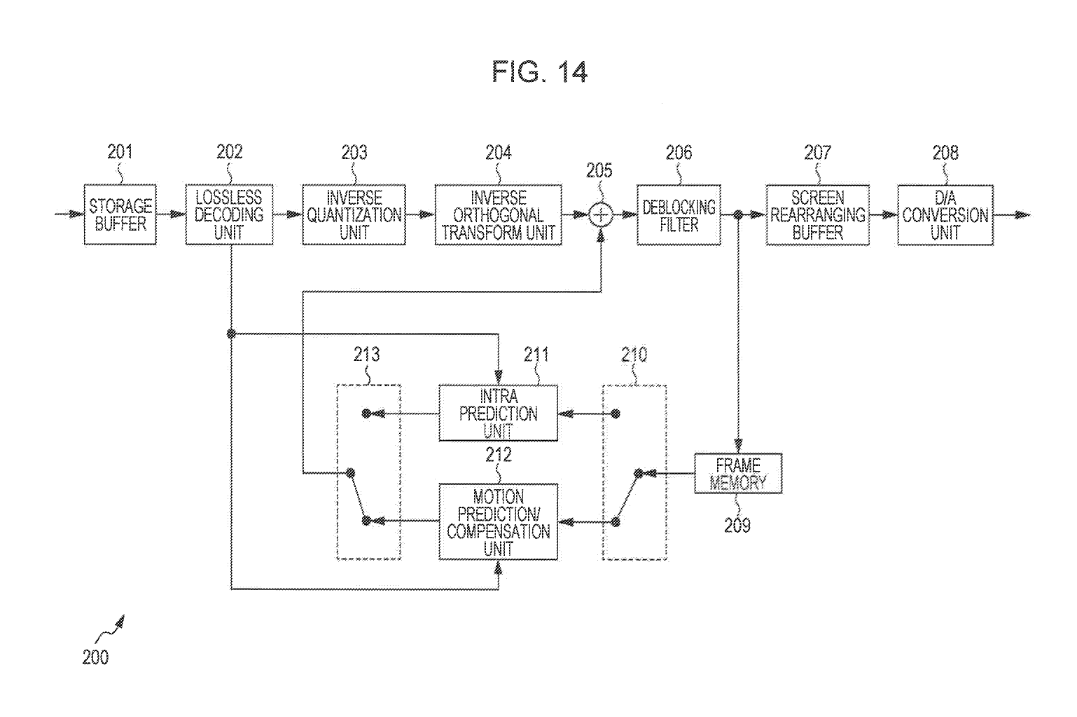

FIG. 14 is a block diagram illustrating a primary configuration example of the image decoding device. The image decoding device 200 shown in FIG. 14 is a decoding device corresponding to the image encoding device 100 in FIG. 7.

The encoded data encoded by the image encoding device 100 is transmitted to the image decoding device 200 corresponding to the image encoding device 100 via a predetermined transmission path, and is decoded.

As shown in FIG. 14, an image decoding device 200 is configured of a storing buffer 201, a lossless decoding unit 202, an inverse quantization unit 203, an inverse orthogonal transform unit 204, a computing unit 205, a deblocking filter 206, a screen rearranging buffer 207 and a D/A conversion unit 208. The image decoding device 200 also has frame memory 209, a selecting unit 210, an intra prediction unit 211, a motion prediction/compensation unit 212, and a selecting unit 213.

The storing buffer 201 stores encoded data transmitted thereto. This encoded data has been encoded by the image encoding device 100. The lossless decoding unit 202 decodes encoded data read out from the storing buffer 201 at a predetermined timing using a format corresponding to the encoding format of the lossless encoding unit 106 in FIG. 7.

The inverse quantization unit 203 subjects the obtained coefficient data decoded by the lossless decoding unit 202 (quantized coefficient) to inverse quantization using a format corresponding to the quantization format of the quantization unit 105 in FIG. 7.

The inverse quantization unit 203 supplies the coefficient data subjected to inverse quantization, i.e., the orthogonal transform coefficient, to the inverse orthogonal transform unit 204. The inverse orthogonal transform unit 204 subjects the orthogonal transform coefficient to inverse orthogonal transform using a format corresponding to the orthogonal transform format of the orthogonal transform unit 104 in FIG. 7, and obtains decoded residual data corresponding to the residual data before orthogonal transform at the image encoding device 100.

The decoded residual data obtained by being subjected to inverse orthogonal transform is supplied to the computing unit 205. Also, the computing unit 205 is supplied with a prediction image from the intra prediction unit 211 or motion prediction/compensation unit 212, via the selecting unit 213.

The computing unit 205 adds the decoded residual data and the prediction image, and obtains decoded image data corresponding to the image data before subtraction of the prediction image by the computing unit 103 of the image encoding device 100. The computing unit 205 supplies the decoded image data to the deblocking filter 206.

The deblocking filter 206 removes the block noise of the supplied decoded image, and subsequently supplies this to the screen rearranging buffer 207.

The screen rearranging buffer 207 performs rearranging of images. That is to say, the order of frames rearranged for encoding by the screen rearranging buffer 102 in FIG. 7 is rearranged to the original display order. The D/A conversion unit 208 performs D/A conversion of the image supplied from the screen rearranging buffer 207, outputs to an unshown display, and displays.

The output of the deblocking filter 206 is further supplied to the frame memory 209.

The frame memory 209, selecting unit 210, intra prediction unit 211, motion prediction/compensation unit 212, and selecting unit 213, each correspond to the frame memory 112, selecting unit 113, intra prediction unit 114, motion prediction/compensation unit 115, and selecting unit 116, of the image encoding device 100 shown in FIG. 7.

The selecting unit 210 reads out the image for inter processing and the image to be referenced from the frame memory 209, and supplies to the motion prediction/compensation unit 212. Also, the selecting unit 210 read out the image to be used for intra prediction from the frame memory 209, and supplies this to the intra prediction unit 211.

The intra prediction unit 211 is supplied with information indicating intra prediction mode obtained by decoding the header information and so forth, from the lossless decoding unit 202, as appropriate. The intra prediction unit 211 generates a prediction image from the reference image obtained form the frame memory 209, based on this information, and supplies the generated prediction image to the selecting unit 213.

The motion prediction/compensation unit 212 obtains information obtained by decoding the header information (prediction mode information, motion vector information, reference frame information, flags, and various types of parameters and so forth) from the lossless decoding unit 202.

The motion prediction/compensation unit 212 generates a prediction image from the reference image obtained from the frame memory 209, based on the information supplied from the lossless decoding unit 202, and supplies the generated prediction image to the selecting unit 213.

The selecting unit 213 selects a prediction image generated by the motion prediction/compensation unit 212 or the intra prediction unit 211, and supplies this to the computing unit 205.

### [Motion Prediction/Compensation Unit]

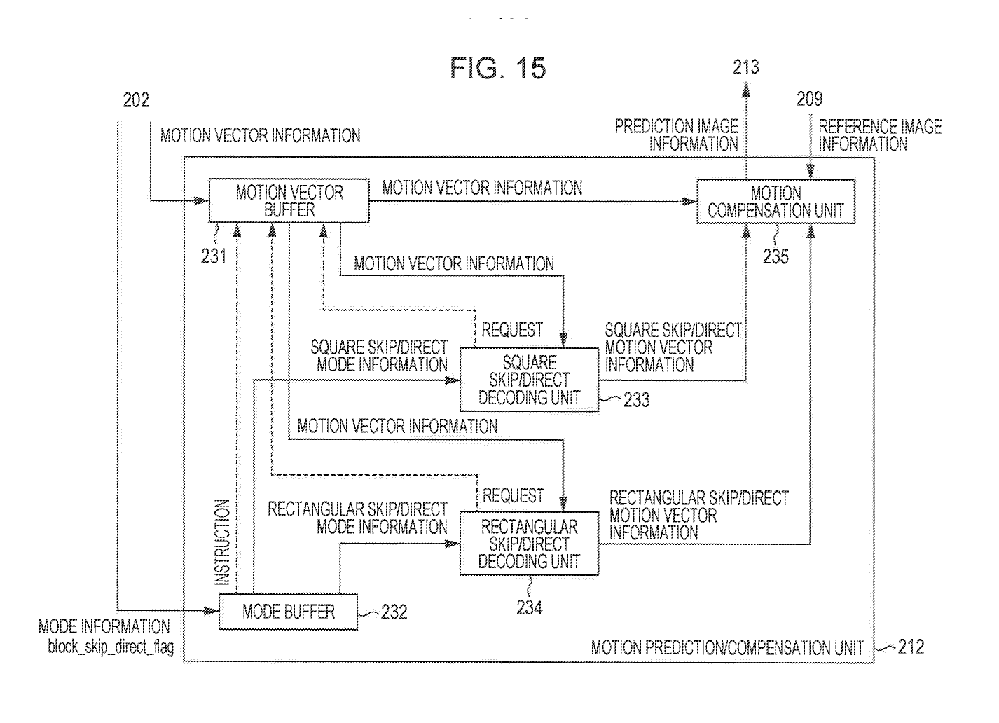

FIG. 15 is a block diagram illustrating a primary configuration example of the motion prediction/compensation unit 212 in FIG. 14.

As shown in FIG. 15, the motion prediction/compensation unit 212 includes a motion vector buffer 231, a mode buffer 232, a square skip/direct decoding unit 233, a rectangular skip/direct decoding unit 234, and a motion compensation unit 235.

The motion vector buffer 231 obtains and holds motion vector information decoded at the inverse decoding unit 202. The mode buffer 232 holds the mode information and block_skip_direct_flag and so forth decoded at the inverse decoding unit 202.

The mode buffer 232 performs instruction to the motion vector buffer 231, to supply the motion vector information to the motion compensation unit 235 in the event of not the skip mode or direct mode, based on the obtained mode information and block_skip_direct_flag. The motion vector buffer 231 supplies the motion vector information of the motion partition to be processed to the motion compensation unit 235, following the instruction.

Also, in the event that this is skip mode or direct mode of a square motion partition, based on the obtained mode information and block_skip_direct_flag, the mode buffer 232 supplies square skip/direct mode information making notification to that effect to the square skip/direct decoding unit 233.

The square skip/direct decoding unit 233 supplies the position and shape of the motion partition to be processed, included in the square skip/direct mode information, to the motion vector buffer 231, and requests motion vector information of adjacent partitions, necessary to generate a motion vector for the motion partition to be processed.

The motion vector buffer 231 identifies the adjacent partitions in accordance with the request, and supplies the motion vector information to the square skip/direct decoding unit 233. The square skip/direct decoding unit 233 uses the motion vectors obtained from the motion vector buffer 231 to generate a motion vector for the motion partition to be processed in the skip mode or direct mode, and supplies the square skip/direct motion vector information to the motion compensation unit 235.

Further, in the event that that this is skip mode or direct mode of a rectangular motion partition, based on the obtained mode information and block_skip_direct_flag, the mode buffer 232 supplies rectangular skip/direct mode information making notification to that effect to the rectangular skip/direct decoding unit 234.

The rectangular skip/direct decoding unit 234 supplies the position and shape of the motion partition to be processed, included in the rectangular skip/direct mode information, to the motion vector buffer 231, and requests motion vector information of adjacent partitions, necessary to generate a motion vector for the motion partition to be processed.

The motion vector buffer 231 identifies the adjacent partitions in accordance with the request, and supplies the motion vector information to the rectangular skip/direct decoding unit 234. The rectangular skip/direct decoding unit 234 uses the motion vectors obtained from the motion vector buffer 231 to generate a motion vector for the motion partition to be processed in the skip mode or direct mode, and supplies the rectangular skip/direct motion vector information to the motion compensation unit 235.

The motion compensation unit 235 obtains reference image information from the frame memory 209, using the supplied motion vector information, and generates a prediction image using this. The motion compensation unit 235 supplies the generated prediction image to the selecting unit 213 as a prediction image for inter prediction mode (prediction image information)

### [Rectangular Skip/Direct Decoding Unit]

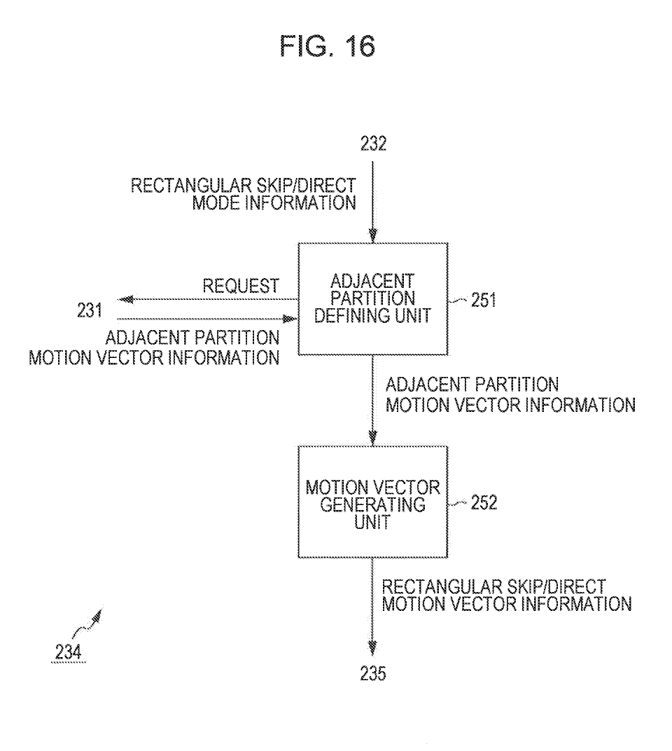

FIG. 16 is a block diagram illustrating a primary configuration example of the rectangular skip/direct decoding unit 234 in FIG. 15. As shown in FIG. 16, the rectangular skip/direct decoding unit 234 has an adjacent partition defining unit 251 and a motion vector generating unit 252.

Upon receiving the rectangular skip/direct mode information from the mode buffer 232, the adjacent partition defining unit 251 supplies information relating to the position and shape of the motion partition to be processed to the motion vector buffer 231, and requests motion vector information of adjacent partitions, necessary to generate a motion vector for the motion partition to be processed.

Upon receiving the adjacent portion motion vector information from the motion vector buffer 231, the adjacent partition defining unit 251 supplies this to the motion vector generating unit 252.

The motion vector generating unit 252 uses the supplied adjacent partition motion vector information to generate motion vector information to the motion partition to be processed, in the skip mode or direct mode.

The motion vector generating unit 252 supplies the rectangular skip/direct motion vector information including the generated motion vector to the motion compensation unit 235.

As described above, the image decoding device 200 decodes a code stream encoded by the image encoding device 100 with a method corresponding to the encoding method of the image encoding device 100. The motion prediction/compensation unit 212 detects skip mode or direct mode of rectangular motion partitions, based on mode information and the block_skip_direct_flag, and generates a motion vector at the rectangular skip/direct decoding unit 234. That is to say, the image decoding unit 200 can correctly decode code streams to which skip mode or direct mode have been applied, with regard to rectangular motion partitions, as well.

Accordingly, the image decoding unit 200 can improve encoding efficiency.

### [Flow of Decoding Processing]

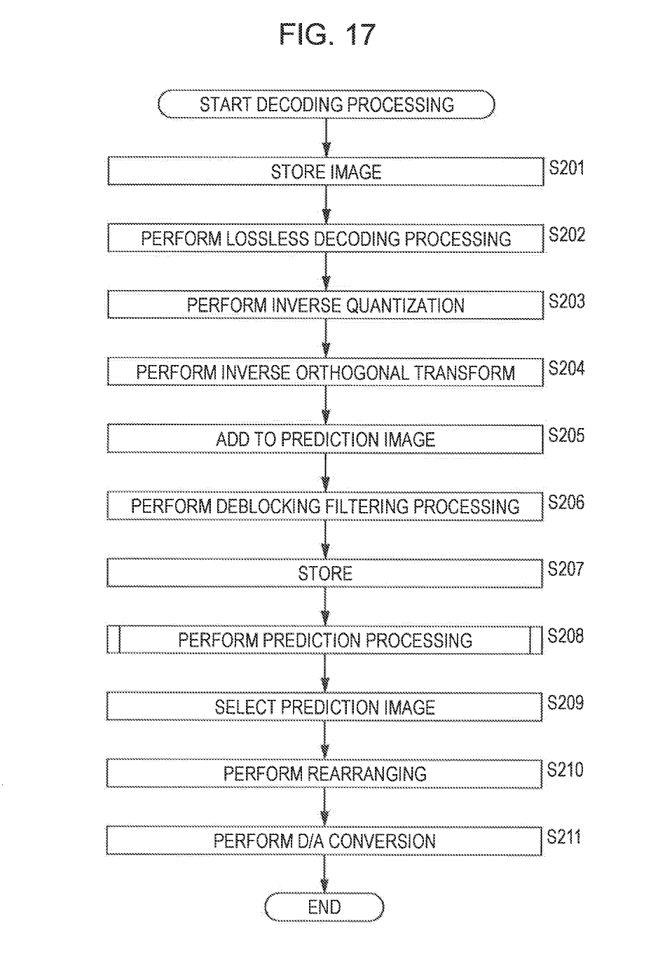

Next, the flow of each processing executed by the above-described image decoding device 200 will be described. First, an example of the flow of decoding processing will be described with reference to the flowchart in FIG. 17.

Upon the decoding processing being started, in step S201, the storing buffer 201 stores the transmitted encoded data. In step S202, the lossless decoding unit 202 decodes the encoded data supplied from the storing buffer 201. Specifically, the T picture, P picture, and B picture encoded by the lossless encoding unit 106 in FIG. 7 are decoded.

At this time, the motion vector information, reference frame information, prediction mode information (intra prediction mode or inter prediction mode), and information such as flags and quantization parameters and so forth, are also decoded.

Specifically, in the event that the prediction mode information is intra prediction mode information, the prediction mode information is supplied to the intra prediction unit 211. In the event that the prediction mode information is inter prediction mode information, prediction mode information and corresponding motion vector information are supplied to the motion prediction/compensation unit 212.

In step S203, the inverse quantization unit 203 inversely quantizes the quantized orthogonal transform coefficient obtained by being decoded at the lossless decoding unit 202 using a method corresponding to the quantizing processing of the quantization unit 105 in FIG. 7. In step S204, the inverse orthogonal transform unit 204 subjects the orthogonal transform coefficient inversely quantized by the inverse quantization unit 203 to inverse orthogonal transform using a method corresponding to the orthogonal transform unit 104 in FIG. 7. This means that difference information corresponding to the input of the orthogonal transform unit 104 in FIG. 7 (the output of the computing unit 103) has been decoded.

In step S205, the computing unit 205 adds the prediction image to the difference information obtained by the processing in step S204. Thus, the original image data is decoded.

In step S206, the deblocking filter 206 subjects the decoded image data obtained by the processing in step S205 to filtering. Thus, block distortion is removed from the decoded image as appropriate.

In step S207, the frame memory 209 stores the decoded image data subjected to filtering.

In step S208, the intra prediction unit 211 or motion prediction/compensation unit 212 performs the respective image prediction processing in accordance with the prediction mode information supplied from the lossless decoding unit 202.

That is to say, in the event that intra prediction mode information is supplied from the lossless decoding unit 202, the intra prediction unit 211 performs intra prediction mode intra prediction processing. Also, in the event that inter prediction mode information is supplied from the lossless decoding unit 202, the motion prediction/compensation unit 212 performs inter prediction mode motion prediction processing.

In step S209, the selecting unit 213 selects a prediction image. That is to say, the selecting unit 213 is supplied with a prediction image generated by the intra prediction unit 211, or, a prediction image generated by the motion prediction/compensation unit 212. The selecting unit 213 selects the side regarding which the prediction image has been supplied, and supplies this prediction image to the computing unit 205. This prediction image is added to the difference information by the processing in step S205.

In step S210, the screen rearranging buffer 207 performs rearranging frames of the decoded image data. Specifically, the sequence of frames of the decoded image data rearranged for encoding by the screen rearranging buffer 102 (FIG. 7) of the image encoding device 100 is rearranged in the original display sequence.

In step S211, the D/A conversion unit 208 performs D/A conversion of the decoded image data from the screen rearranging buffer 207 regarding which the frames have been rearranged. This decoded image data is output to an unshown display, and the image is displayed.

### [Flow of Prediction Processing]

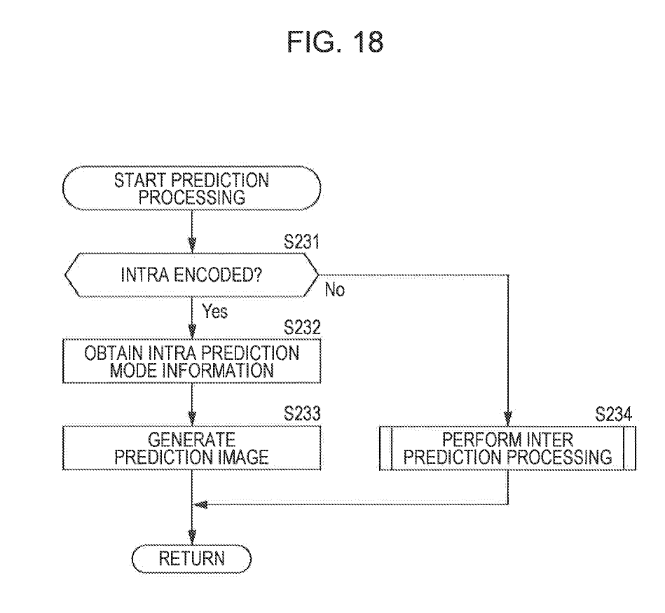

Next, an example of the detailed flow of prediction processing executed in step S208 of FIG. 17 will be described with reference to the flowchart in FIG. 18.

Upon prediction processing being started, in step S231 the lossless decoding unit 202 determines whether or not the encoded data has been intra encoded, based on the decoded prediction mode information.

In the event that determination is made that this has been intra encoded, the lossless decoding unit 202 advances the flow to step S232.

In step S232, the intra prediction unit 211 obtains information necessary for generating a prediction image, such as intra prediction mode information and so forth, from the lossless decoding unit 202. In step S233, the intra prediction unit 211 obtains a reference image from the frame memory 209, performs intra prediction processing in intra prediction mode, and generates a prediction image.

Upon generating the prediction image, the intra prediction unit 211 supplies the generated prediction image to the computing unit 205 via the selecting unit 213, ends the prediction processing, returns the processing to step S208 in FIG. 17, and causes subsequent processing from step S209 to be executed.

Also, in the event that determination is made in step S231 in FIG. 18 that this has been inter encoded, the lossless decoding unit 202 advances the flow to step S234.

In step S234, the motion prediction/compensation unit 212 performs inter prediction processing, and generates a prediction image in the inter prediction mode employed at the time of encoding.

Upon generating the prediction image, the motion prediction/compensation unit 212 supplies the generated prediction image to the computing unit 205 via the selecting unit 213, ends the prediction processing, returns the processing to step S208 in FIG. 17, and causes subsequent processing from step S209 to be executed.

### [Flow of Inter Prediction Processing]

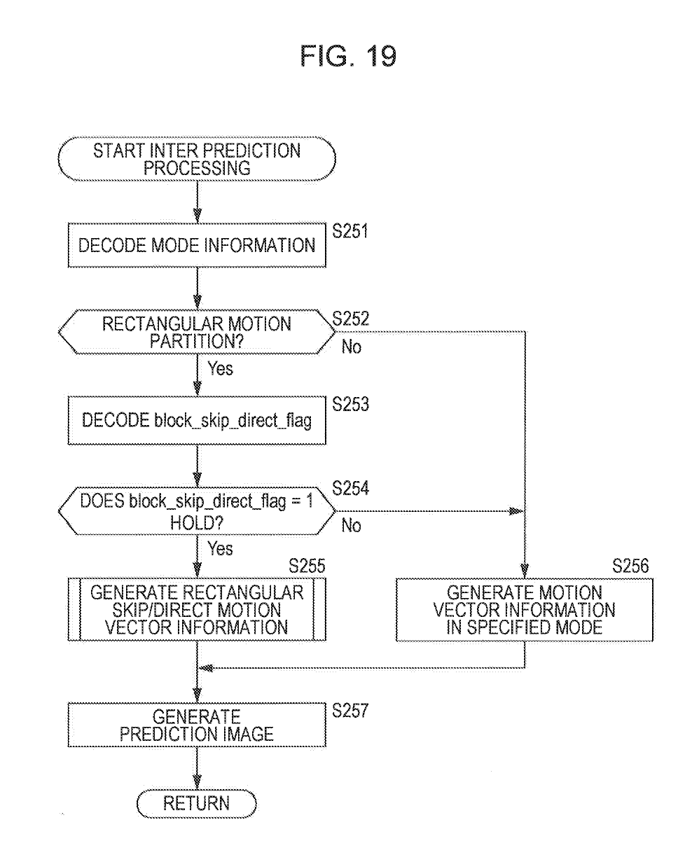

Next, an example of the flow of inter prediction processing executed in step S234 of FIG. 18 will be described with reference to the flowchart in FIG. 19.

Upon inter prediction processing being started, in step S251 the lossless decoding unit 202 decodes mode information. In step S252, the mode buffer 232 determines whether or not the object of processing is a rectangular motion partition, from the decoded mode information. In the event that determination is made that this is a rectangular motion partition, the mode buffer 232 advances the processing to step S253.

In step S253, the lossless decoding unit 202 decodes the block_skip_direct_flag. In step S254, the mode buffer 232 determines whether or not the value of the block_skip_direct_flag is 1. In the event that determination is made that block_skip_direct_flag is 1, the mode buffer 232 advances the processing to step S255.

In step S255, the rectangular skip/direct decoding unit 234 performs rectangular skip/direct motion vector information generating processing, where a motion vector is generated from motion vectors of adjacent partitions. This rectangular skip/direct motion vector information generating processing is performed in the same way as with the case described with reference to the flowchart in FIG. 13.

Upon the rectangular skip/direct motion vector information having been generated, the rectangular skip/direct decoding unit 234 advances the flow to step S257

Also, in the event that determination is made in step S252 that the object of processing is not a rectangular motion partition, the mode buffer 232 advances the processing to step S256. Further, in the event that determination is made in step S254 that block_skip_direct_flag is 0, the mode buffer 232 advances the processing to step S256.

In step S256, the motion vector buffer 231 or square skip/direct decoding unit 233 generates motion vector information in the specified mode. Actually, in a case of other than the skip mode o or direct mode, the motion vector buffer 231 selects motion vector information of the motion partition to be processed, which has been decoded, and in the case of the skip mode or direct mode, the square skip/direct decoding unit 233 generates motion vector information of the motion partition to be processed, from motion vectors of adjacent partitions.

Upon the processing of step S256 ending, the motion vector buffer 231 or square skip/direct decoding unit 233 advances the flow to step S257.

In step S257, the motion compensation unit 235 generates a prediction image using the prepared motion vector information.

Upon the processing of step S257 ending, the motion compensation unit 235 ends the inter prediction processing, returns the processing to step S234 in FIG. 18, ends the prediction processing returns the processing to step S208 in FIG. 17, and causes the subsequent processing to be executed.

Thus, the image decoding device 200 can correctly decode a code stream encoded by the image encoding device 100. Accordingly, the image decoding device 200 can improve encoding efficiency.

Note that description has been made with regard to the first embodiment and second embodiment that the skip mode and direct mode are applied to rectangular motion partitions for just extended macroblocks, but is not restricted to this.

For example, an arrangement may be made where skip mode and direct mode are applied to rectangular motion partitions for just macrobocks of size of 32×32 pixels or 64×64 pixels or greater, or an arrangement may be made where skip mode and direct mode are applied to rectangular motion partitions for just macroblocks of sizes of 8×8 pixels or 4×4 pixels or greater, or an arrangement may be made where skip mode and direct mode are applied to rectangular motion partitions for macroblocks of all sizes.

Also, while description has been made with regard to the first embodiment and second embodiment that skip mode and direct mode are applied only in cases of taking rectangular sub macroblocks which divide a macroblock into two as motion partitions, but is not restricted to this. Skip mode and direct mode can be applied in cases of taking rectangular sub macroblocks which divide a macroblock into three or more as motion partitions.

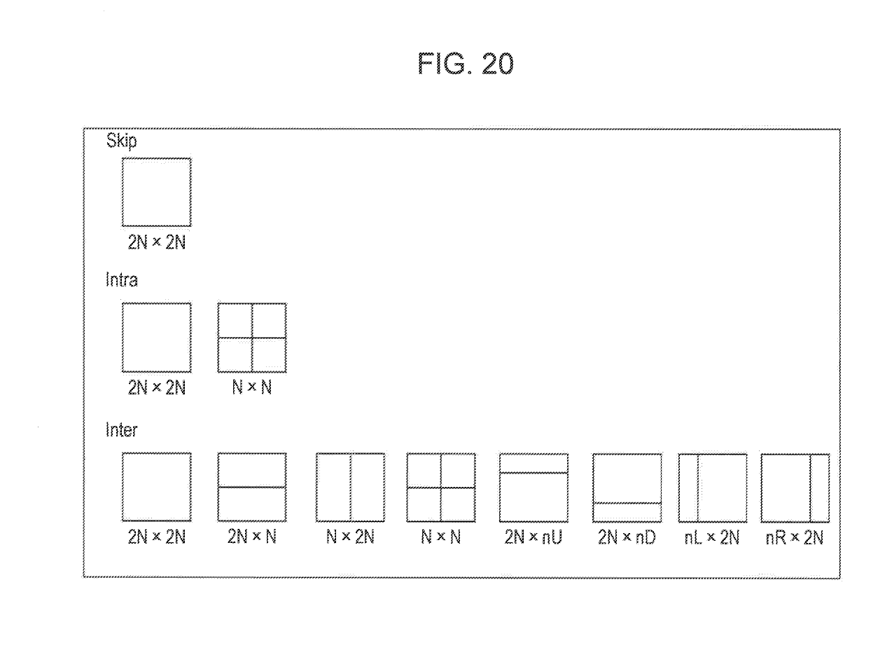

Further, this can be applied to partitions of any shape, as long as non-square motion partitions. For example, with Ken McCann, Woo-Jin Han, Il-Koo Kim “Samsung's Response to the Call for Proposals on Video Compression Technology”, JCTVC-A124, April 2010 (hereinafter referred to as NPL 2), motion partitions according to asymmetrical division such as shown in FIG. 20 is proposed. An arrangement may be made where motion partitions which divide into two with such asymmetrical division are taken as the above-described rectangular motion partitions, with skip mode and direct mode being applied.

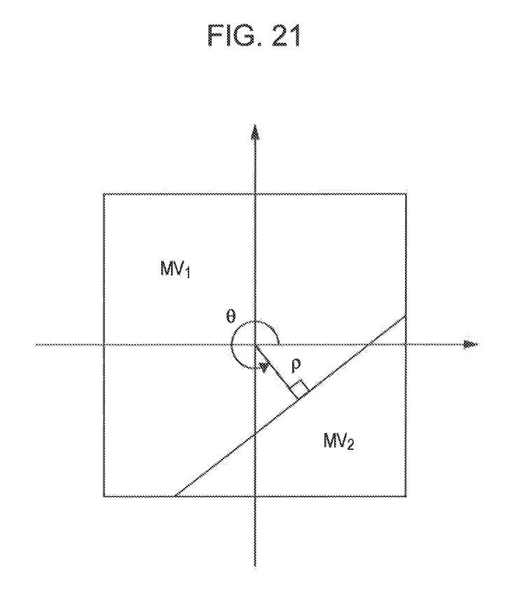

Also, with Marta Karczewicz, Peisong Chen, Rajan Joshi, Xianglin Wang, Wei-Jung Chien, Rahul Panchal, “Video coding technology proposal by Qualcomm Inc.”, JCTVC-A121, April 2010 (hereinafter referred to as NPL 3), a proposal is made of a motion compensation partition mode where θ and ρ are taken as encoding parameters, and division is made obliquely, as shown in FIG. 21. An arrangement may be made where motion partitions divided two ways according to such oblique division are taken as the above-described rectangular motion partitions, with skip mode and direct mode being applied.

Note that as described above, generally, the greater a region skip mode or direct mode is applied to, the greater the contribution to improved encoding efficiency is. In other words, applying skip mode or direct mode to very small regions does not contribute to improved encoding efficiency very much. Accordingly, an arrangement may be made where a limit is provided to the size of an area where skip mode or direct mode is to be applied, such that application is made only for regions greater than a predetermined threshold value.

Particularly, in the case of the dividing methods illustrated in FIG. 20 and FIG. 21, it can be conceived that extremely small regions will be generated. Accordingly, an arrangement may be made where a restriction (minimum value) is provided for the size of regions to be taken as rectangular motion partitions, thereby keeping the skip mode and direct mode from being applied to such regions, thereby reducing the load of encoding processing.

Now, in order to improve motion vector encoding using median prediction, such as shown in FIG. 3, Jungyoup Yang, Kwanghyun Won, Byeungwoo Jeon, Hayoon Kim, “Motion Vector Coding with Optimal PMV Selection”, VCEG-AI22, July 2008 (hereinafter referred to as NPL 4), the following method is proposed.

That is to say, in addition to “Spatial Predictor (spatial prediction)” obtained by median prediction, which is defined in the AVC encoding format, one of the later-described “Temporal Predictor (temporal prediction)” and “Spatio-Temporal Predictor (spatio-temporal prediction)” is adaptively used as prediction motion vector information.

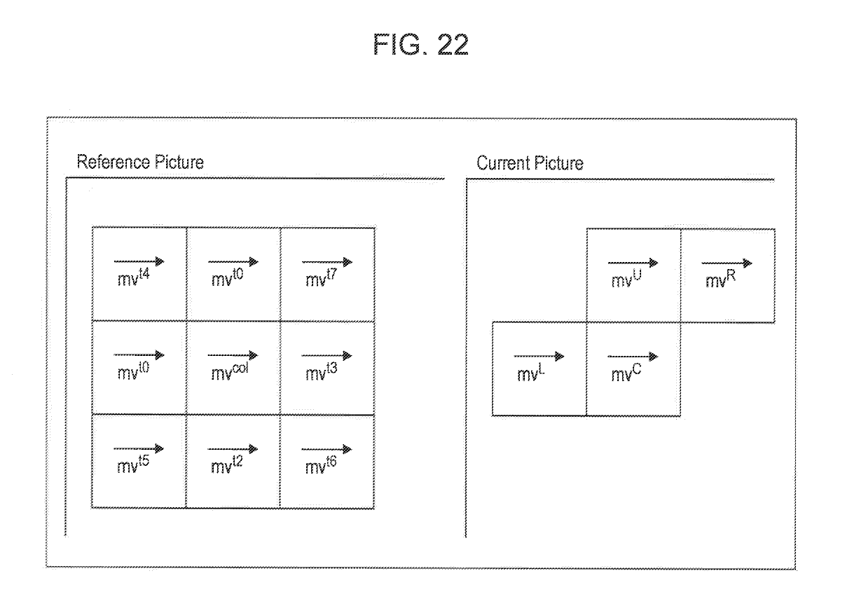

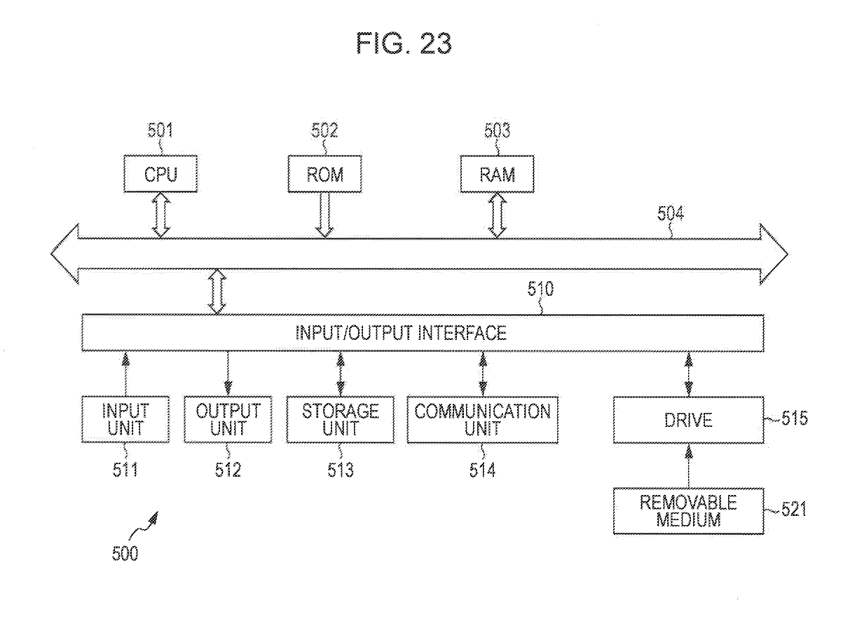

That is to say, in FIG. 22, with “mvcol” as motion vector information as to a co-located block as to the current block (a block of which the xy coordinates in the reference image is the same as those in the current block), and mvtk (k=0 through 8) as motion vector information of the surrounding blocks, the respective prediction motion vector information (Predictor) are defined by the following Expressions (17) through (19)

### Temporal Predictor:

[Mathematical Expression 14]

mvₜₘ₅=median{mv_{col},mvₜ₀, . . . ,mvₜ₃} (17)

[Mathematical Expression 15]

mvₜₘ₉=median{mv_{col},mvₜ₀, . . . ,mvₜ₈} (18)

### Spatio-Temporal Predictor:

[Mathematical Expression 16]

mvₛₚₜ=median{mv_{col},mv_{col},mvₐ,mv_{b},mv_{c},} (19)

With the image encoding device 100, cost functions are calculated using respective prediction motion vector information for each block, and optimal prediction motion vector information is selected. With the image compression information, a flag indicating information relating to which prediction motion vector information has been used is transmitted with regard to each block.

The present technology can also be applied at the time of performing motion vector encoding by Motion Vector Competition, such s shown in FIG. 22.

While description has been made above of an image encoding device which performs encoding according to a format compliant with AVC, and an image decoding device which performs decoding according to a format compliant with AVC, but the scope of application of the present technology is not restricted to this, and encoding processing involving skip mode or direct mode motion prediction/compensation can be applied to all image encoding devices and image decoding devices.

Also, information such as the block_skip_direct_flag described above can be added to a predetermined position in the encoded data, for example, or may be transmitted to the decoding side separately from the encoded data. For example, the lossless encoding unit 106 may describe these information in a bit stream as a syntax. Also, the lossless encoding unit 106 may store these information in a predetermined region as auxiliary information, and transmit. For example, these information may be stored in a parameter set (e.g., sequence or picture header or the like) of SEI (Supplemental Enhancement Information) or the like.

Also, an arrangement may be made where the lossless encoding unit 106 transmits these information from the image encoding device 100 to the image decoding device 200 separately from the encoded data (as a separately file). In this case, there is the need to clarify the correlation between these information and the encoded data (enable comprehension at the decoding side), the method of which is optional. For example, table information indicating the correlation may be created separately, or link information indicating the correlating data may be embedded in each other's data.

### 3. Third Embodiment

### [Personal Computer]

The above-described series of processing may be executed by hardware, and may be executed by software. In this case, a configuration may be made as a personal computer such as shown in FIG. 22, for example.

In FIG. 22, a CPU (Central Processing Unit) 501 of a personal computer 500 executes various types of processing following programs stored in ROM (Read Only Memory) 502 or programs loaded to RAM (Random Access Memory) 503 from a storage unit 513. The RAM 503 also stores data and so forth necessary for the CPU 501 to execute various types of processing, as appropriate.

The CPU 501, ROM 502, and RAM 503 are mutually connected by a bus 504. This bus 504 is also connected to an input/output interface 510.

Connected to the input/output interface 510 is an input unit 511 made up of a keyboard, a mouse, and so forth, an output unit 512 made up of a display such as a CRT (Cathode Ray Tube) or LCD (Liquid Crystal Display) or the like, a speaker, and so forth, a storage unit 513 made up of a hard disk and so forth, and a communication unit 514 made up of a modem and so forth. The communication unit 514 performs communication processing via networks including the Internet.

Also connected to the input/output interface 510 is a drive 515 as necessary, to which a removable medium 521 such as a magnetic disk, an optical disc, a magneto-optical disk, semiconductor memory, or the like, is mounted as appropriate, and computer programs read out therefrom are installed in the storage unit 513 as necessary.

In the event of executing the above-described series of processing by software, a program configuring the software is installed from a network or recording medium.

As shown in FIG. 22, for example, this recording medium is not only configured of a removable medium 521 made up of a magnetic disk (including flexible disk), optical disc (including CD-ROM (Compact Disc-Read Only Memory), DVD (Digital Versatile Disc), magneto-optical disc (MD (Mini Disc)), or semiconductor memory or the like, in which programs are recorded and distributed so as to distribute programs to users separately from the device main unit, but also is configured of ROM 502, a hard disk included in the storage unit 513, and so forth, in which programs are recorded, distributed to users in a state of having been built into the device main unit beforehand.

Note that a program which the computer executes may be a program in which processing is performed in time sequence following the order described in the present Specification, or may be a program in which processing is performed in parallel, or at a necessary timing, such as when a call-up has been performed.

Also, with the present specification, steps describing programs recorded in the recording medium includes processing performed in time sequence following the described order as a matter of course, and also processing executed in parallel or individually, without necessarily being processed in time sequence.

Also, with the present specification, the term system represents the entirety of devices configured of multiple devices (devices).

Also, a configuration which has been described above as one device (or processing unit) may be divided and configured as multiple devices (or processing units). Conversely, configurations which have been described above as multiple devices (or processing units) may be integrated and configured as a single device (or processing unit). Also, configurations other than those described above may be added to the devices (or processing units), as a matter of course. Further, part of a configuration of a certain device (or processing unit) may be included in a configuration of another device (or another processing unit), as long as the configuration and operations of the overall system is substantially the same. That is to say, the embodiments of the present technology are not restricted to the above-described embodiments, and that various modifications may be made without departing from the essence of the present technology.

For example, the above-described image encoding device and image decoding device may be applied to any desired electronic devices. The following is a description of examples thereof.

### 4. Fourth Embodiment

### [Television Receiver]

FIG. 23 is a block diagram illustrating a principal configuration example of a television receiver using the image decoding device 200.

A television receiver 1000 shown in FIG. 23 includes a terrestrial tuner 1013, a video decoder 1015, a video signal processing circuit 1018, a graphics generating circuit 1019, a panel driving circuit 1020, and a display panel 1021.

The terrestrial tuner 1013 receives the broadcast wave signals of a terrestrial analog broadcast via an antenna, demodulates, obtains video signals, and supplies these to the video decoder 1015. The video decoder 1015 subjects the video signals supplied from the terrestrial tuner 1013 to decoding processing, and supplies the obtained digital component signals to the video signal processing circuit 1018.

The video signal processing circuit 1018 subjects the video data supplied from the video decoder 1015 to predetermined processing such as noise removal or the like, and supplies the obtained video data to the graphics generating circuit 1019.

The graphics generating circuit 1019 generates the video data of a program to be displayed on a display panel 1021, or image data due to processing based on an application to be supplied via a network, or the like, and supplies the generated video data or image data to the panel driving circuit 1020. Also, the graphics generating circuit 1019 also performs processing such as supplying video data obtained by generating video data (graphics) for the user displaying a screen used for selection of an item or the like, and superimposing this on the video data of a program, to the panel driving circuit 1020 as appropriate.

The panel driving circuit 1020 drives the display panel 1021 based on the data supplied from the graphics generating circuit 1019 to display the video of a program, or the above-mentioned various screens on the display panel 1021.

The display panel 1021 is made up of an LCD (Liquid Crystal Display) and so forth, and displays the video of a program or the like in accordance with the control by the panel driving circuit 1020.

Also, the television receiver 1000 also includes an audio A/D (Analog/Digital) conversion circuit 1014, an audio signal processing circuit 1022, an echo cancellation/audio synthesizing circuit 1023, an audio amplifier circuit 1024, and a speaker 1025.

The terrestrial tuner 1013 demodulates the received broadcast wave signal, thereby obtaining not only a video signal but also an audio signal. The terrestrial tuner 1013 supplies the obtained audio signal to the audio A/D conversion circuit 1014.

The audio A/D conversion circuit 1014 subjects the audio signal supplied from the terrestrial tuner 1013 to A/D conversion processing, and supplies the obtained digital audio signal to the audio signal processing circuit 1022.

The audio signal processing circuit 1022 subjects the audio data supplied from the audio A/D conversion circuit 1014 to predetermined processing such as noise removal or the like, and supplies the obtained audio data to the echo cancellation/audio synthesizing circuit 1023.

The echo cancellation/audio synthesizing circuit 1023 supplies the audio data supplied from the audio signal processing circuit 1022 to the audio amplifier circuit 1024.

The audio amplifier circuit 1024 subjects the audio data supplied from the echo cancellation/audio synthesizing circuit 1023 to D/A conversion processing, subjects to amplifier processing to adjust to predetermined volume, and then outputs the audio from the speaker 1025.

Further, the television receiver 1000 also includes a digital tuner 1016, and an MPEG decoder 1017.

The digital tuner 1016 receives the broadcast wave signals of a digital broadcast (terrestrial digital broadcast, BS (Broadcasting Satellite)/CS (Communications Satellite) digital broadcast) via the antenna, demodulates to obtain MPEG-TS (Moving Picture Experts Group-Transport Stream), and supplies this to the MPEG decoder 1017.

The MPEG decoder 1017 descrambles the scrambling given to the MPEG-TS supplied from the digital tuner 1016, and extracts a stream including the data of a program serving as a playing object (viewing object). The MPEG decoder 1017 decodes an audio packet making up the extracted stream, supplies the obtained audio data to the audio signal processing circuit 1022, and also decodes a video packet making up the stream, and supplies the obtained video data to the video signal processing circuit 1018. Also, the MPEG decoder 1017 supplies EPG (Electronic Program Guide) data extracted from the MPEG-TS to a CPU 1032 via an unshown path.

The television receiver 1000 uses the above-mentioned image decoding device 200 as the MPEG decoder 1017 for decoding video packets in this way. Note that the MPEG-TS transmitted from the broadcasting station or the like has been encoded by the image encoding device 100.

The MPEG decoder 1017 can detect skip mode and direct mode of rectangular motion partitions based on mode information and the block_skip_direct_flag, and perform decoding processing in the respective modes, in the same way as with the image decoding device 200. Accordingly, the MPEG decoder 1017 can correctly decode code streams where skip mode and direct mode are applied to rectangular motion partitions, and thereby can improve encoding efficiency.

The video data supplied from the MPEG decoder 1017 is, in the same way as with the case of the video data supplied from the video decoder 1015, subjected to predetermined processing at the video signal processing circuit 1018, superimposed on the generated video data and so forth at the graphics generating circuit 1019 as appropriate, supplied to the display panel 1021 via the panel driving circuit 1020, and the image thereof is displayed thereon.

The audio data supplied from the MPEG decoder 1017 is, in the same way as with the case of the audio data supplied from the audio A/D conversion circuit 1014, subjected to predetermined processing at the audio signal processing circuit 1022, supplied to the audio amplifier circuit 1024 via the echo cancellation/audio synthesizing circuit 1023, and subjected to D/A conversion processing and amplifier processing. As a result thereof, the audio adjusted in predetermined volume is output from the speaker 1025.

Also, the television receiver 1000 also includes a microphone 1026, and an A/D conversion circuit 1027.

The A/D conversion circuit 1027 receives the user's audio signals collected by the microphone 1026 provided to the television receiver 1000 serving as for audio conversation, subjects the received audio signal to A/D conversion processing, and supplies the obtained digital audio data to the echo cancellation/audio synthesizing circuit 1023.

In the event that the user (user A)'s audio data of the television receiver 1000 has been supplied from the A/D conversion circuit 1027, the echo cancellation/audio synthesizing circuit 1023 perform echo cancellation with the user A's audio data taken as a object, and outputs audio data obtained by synthesizing the user A's audio data and other audio data, or the like from the speaker 1025 via the audio amplifier circuit 1024.

Further, the television receiver 1000 also includes an audio codec 1028, an internal bus 1029, SDRAM (Synchronous Dynamic Random Access Memory) 1030, flash memory 1031, a CPU 1032, a USB (Universal Serial Bus) I/F 1033, and a network I/F 1034.

The A/D conversion circuit 1027 receives the user's audio signal collected by the microphone 1026 provided to the television receiver 1000 serving as for audio conversation, subjects the received audio signal to A/D conversion processing, and supplies the obtained digital audio data to the audio codec 1028.

The audio codec 1028 converts the audio data supplied from the A/D conversion circuit 1027 into the data of a predetermined format for transmission via a network, and supplies to the network I/F 1034 via the internal bus 1029.

The network I/F 1034 is connected to the network via a cable mounted on a network terminal 1035. The network I/F 1034 transmits the audio data supplied from the audio codec 1028 to another device connected to the network thereof, for example. Also, the network I/F 1034 receives, via the network terminal 1035, the audio data transmitted from another device connected thereto via the network, and supplies this to the audio codec 1028 via the internal bus 1029, for example.

The audio codec 1028 converts the audio data supplied from the network I/F 1034 into the data of a predetermined format, and supplies this to the echo cancellation/audio synthesizing circuit 1023.

The echo cancellation/audio synthesizing circuit 1023 performs echo cancellation with the audio data supplied from the audio codec 1028 taken as a object, and outputs the data of audio obtained by synthesizing the audio data and other audio data, or the like, from the speaker 1025 via the audio amplifier circuit 1024.

The SCRAM 1030 stores various types of data necessary for the CPU 1032 performing processing.

The flash memory 1031 stores a program to be executed by the CPU 1032. The program stored in the flash memory 1031 is read out by the CPU 1032 at predetermined timing such as when activating the television receiver 1000, or the like. EPG data obtained via a digital broadcast, data obtained from a predetermined server via the network, and so forth are also stored in the flash memory 1031.

For example, MPEG-TS including the content data obtained from a predetermined server via the network by the control of the CPU 1032 is stored in the flash memory 1031. The flash memory 1031 supplies the MPEG-TS thereof to the MPEG decoder 1017 via the internal bus 1029 by the control of the CPU 1032, for example.

The MPEG decoder 1017 processes the MPEG-TS thereof in the same way as with the case of the MPEG-TS supplied from the digital tuner 1016. In this way, the television receiver 1000 receives the content data made up of video, audio, and so forth via the network, decodes using the MPEG decoder 1017, whereby video thereof can be displayed, and audio thereof can be output.

Also, the television receiver 1000 also includes a light reception unit 1037 for receiving the infrared signal transmitted from a remote controller 1051.

The light reception unit 1037 receives infrared rays from the remote controller 1051, and outputs a control code representing the content of the user's operation obtained by demodulation, to the CPU 1032.

The CPU 1032 executes the program stored in the flash memory 1031 to control the entire operation of the television receiver 1000 according to the control code supplied from the light reception unit 1037 and so forth. The CPU 1032, and the units of the television receiver 1000 are connected via an unshown path.

The USB I/F 1033 performs transmission/reception of data as to an external device of the television receiver 1000 which is connected via a USE cable mounted on a USE terminal 1036. The network I/F 1034 connects to the network via a cable mounted on the network terminal 1035, also performs transmission/reception of data other than audio data as to various devices connected to the network.

The television receiver 1000, by using the image decoding device 200 as the MPEG decoder 1017, can correctly decode code streams even in cases where broadcast signals received via an antenna or content data obtained via a network are encoded with detect skip mode and direct mode applied to rectangular motion partitions, and thereby can improve encoding efficiency.

### 5. Fifth Embodiment

### [Cellular Telephone]

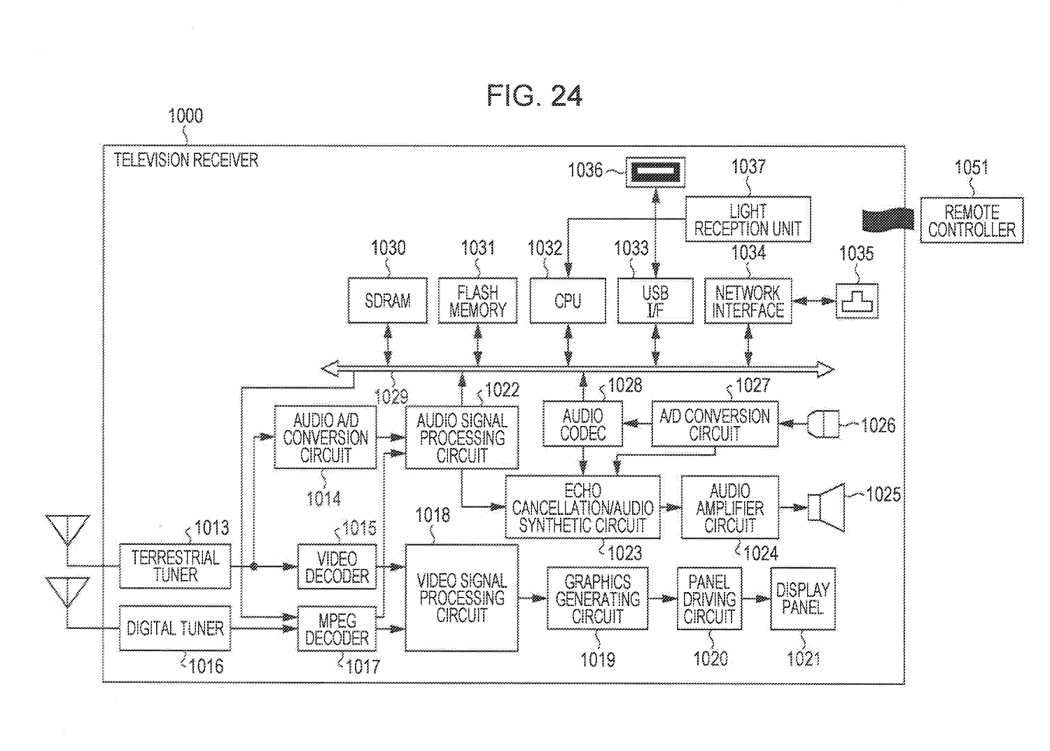

FIG. 24 is a block diagram illustrating a principal configuration example of a cellular telephone using the image encoding device 100 and image decoding device 200.

A cellular telephone 1100 shown in FIG. 24 includes a main control unit 1150 configured so as to integrally control the units, a power supply circuit unit 1151, an operation input control unit 1152, an image encoder 1153, a camera I/F unit 1154, an LCD control unit 1155, an image decoder 1156, a multiplexing/separating unit 1157, a recording/playing unit 1162, a modulation/demodulation circuit unit 1158, and an audio codec 1159. These are mutually connected via a bus 1160.

Also, the cellular telephone 1100 includes operation keys 1119, a CCD (Charge Coupled Devices) camera 1116, a liquid crystal display 1118, a storage unit 1123, a transmission/reception circuit unit 1163, an antenna 1114, a microphone (mike) 1121, and a speaker 1117.

Upon a call end and power key being turned on by the user's operation, the power supply circuit unit 1151 activates the cellular telephone 1100 in an operational state by supplying power to the units from a battery pack.

The cellular telephone 1100 performs various operations, such as transmission/reception of an audio signal, transmission/reception of an e-mail and image data, image shooting, data recoding, and so forth, in various modes such as a voice call mode, a data communication mode, and so forth, based on the control of the main control unit 1150 made up of a CPU, ROM, RAM, and so forth.

For example, in the voice call mode, the cellular telephone 1100 converts the audio signal collected by the microphone (mike) 1121 into digital audio data by the audio codec 1159, subjects this to spectrum spread processing at the modulation/demodulation circuit unit 1158, and subjects this to digital/analog conversion processing and frequency conversion processing at the transmission/reception circuit unit 1163. The cellular telephone 1100 transmits the signal for transmission obtained by the conversion processing thereof to an unshown base station via the antenna 1114. The signal for transmission (audio signal) transmitted to the base station is supplied to the cellular telephone of the other party via the public telephone network.

Also, for example, in the voice call mode, the cellular telephone 1100 amplifies the reception signal received at the antenna 1114, at the transmission/reception circuit unit 1163, further subjects to frequency conversion processing and analog/digital conversion processing, subjects to spectrum inverse spread processing at the modulation/demodulation circuit unit 1158, and converts into an analog audio signal by the audio codec 1159. The cellular telephone 1100 outputs the converted and obtained analog audio signal thereof from the speaker 1117.

Further, for example, in the event of transmitting an e-mail in the data communication mode, the cellular telephone 1100 accepts the text data of the e-mail input by the operation of the operation keys 1119 at the operation input control unit 1152. The cellular telephone 1100 processes the text data thereof at the main control unit 1150, and displays on the liquid crystal display 1118 via the LCD control unit 1155 as an image.

Also, the cellular telephone 1100 generates e-mail data at the main control unit 1150 based on the text data accepted by the operation input control unit 1152, the user's instructions, and so forth. The cellular telephone 1100 subjects the e-mail data thereof to spectrum spread processing at the modulation/demodulation circuit unit 1158, and subjects to digital/analog conversion processing and frequency conversion processing at the transmission/reception circuit unit 1163. The cellular telephone 1100 transmits the signal for transmission obtained by the conversion processing thereof to an unshown base station via the antenna 1114. The signal for transmission (e-mail) transmitted to the base station is supplied to a predetermined destination via the network, mail server, and so forth.

Also, for example, in the event of receiving an e-mail in the data communication mode, the cellular telephone 1100 receives the signal transmitted from the base station via the antenna 1114 with the transmission/reception circuit unit 1163, amplifies, and further subjects to frequency conversion processing and analog/digital conversion processing. The cellular telephone 1100 subjects the reception signal thereof to spectrum inverse spread processing at the modulation/demodulation circuit unit 1158 to restore the original e-mail data. The cellular telephone 1100 displays the restored e-mail data on the liquid crystal display 1118 via the LCD control unit 1155.

Note that the cellular telephone 1100 may record (store) the received e-mail data in the storage unit 1123 via the recording/playing unit 1162.

This storage unit 1123 is an optional rewritable recording medium. The storage unit 1123 may be semiconductor memory such as RAM, built-in flash memory, or the like, may be a hard disk, or may be a removable medium such as a magnetic disk, a magneto-optical disk, an optical disc, USB memory, a memory card, or the like. It goes without saying that the storage unit 1123 may be other than these.

Further, for example, in the event of transmitting image data in the data communication mode, the cellular telephone 1100 generates image data by imaging at the CCD camera 1116. The CCD camera 1116 includes a CCD serving as an optical device such as a lens, diaphragm, and so forth, and serving as a photoelectric conversion device, which images a subject, converts the intensity of received light into an electrical signal, and generates the image data of an image of the subject. The CCD camera 1116 performs encoding of the image data at the image encoder 1153 via the camera I/F unit 1154, and converts into encoded image data.

The cellular telephone 1100 employs the above-mentioned image encoding device 100 as the image encoder 1153 for performing such processing. Accordingly, in the same way as with the case of the image encoding device 100, the skip mode and direct mode are applied to rectangular partitions as well, with motion vector information being calculated as one candidate mode, and cost functions being evaluated. Accordingly, in the same way as with the image encoding device 100, the image encoder 1153 can apply skip mode and direct mode to greater regions, and encoding efficiency can be improved.

Note that, at this time simultaneously, the cellular telephone 1100 converts the audio collected at the microphone (mike) 1121, while shooting with the CCD camera 1116, from analog to digital at the audio codec 1159, and further encodes this.

The cellular telephone 1100 multiplexes the encoded image data supplied from the image encoder 1153, and the digital audio data supplied from the audio codec 1159 at the multiplexing/separating unit 1157 using a predetermined method. The cellular telephone 1100 subjects the multiplexed data obtained as a result thereof to spectrum spread processing at the modulation/demodulation circuit unit 1158, and subjects to digital/analog conversion processing and frequency conversion processing at the transmission/reception circuit unit 1163. The cellular telephone 1100 transmits the signal for transmission obtained by the conversion processing thereof to an unshown base station via the antenna 1114. The signal for transmission (image data) transmitted to the base station is supplied to the other party via the network or the like.

Note that in the event that image data is not transmitted, the cellular telephone 1100 may also display the image data generated at the CCD camera 1116 on the liquid crystal display 1118 via the LCD control unit 1155 instead of the image encoder 1153.

Also, for example, in the event of receiving the data of a moving image file linked to a simple website or the like in the data communication mode, the cellular telephone 1100 receives the signal transmitted from the base station at the transmission/reception circuit unit 1163 via the antenna 1114, amplifies, and further subjects to frequency conversion processing and analog/digital conversion processing. The cellular telephone 1100 subjects the received signal to spectrum inverse spread processing at the modulation/demodulation circuit unit 1158 to restore the original multiplexed data. The cellular telephone 1100 separates the multiplexed data thereof at the multiplexing/separating unit 1157 into encoded image data and audio data.

The cellular telephone 1100 decodes the encoded image data at the image decoder 1156, thereby generating playing moving image data, and displays this on the liquid crystal display 1118 via the LCD control unit 1155. Thus, moving image data included in a moving image file linked to a simple website is displayed on the liquid crystal display 1118, for example.

The cellular telephone 1100 employs the above-mentioned image decoding device 200 as the image decoder 1156 for performing such processing. Accordingly, in the same way as with the image decoding device 200, the image decoder 1156 can detect skip mode and direct mode of rectangular motion partitions, and perform decoding processing in the respective modes. Accordingly, the image decoder 1156 can correctly decode code streams where skip mode and direct mode are applied to rectangular motion partitions, and thereby can improve encoding efficiency.

At this time, simultaneously, the cellular telephone 1100 converts the digital audio data into an analog audio signal at the audio codec 1159, and outputs this from the speaker 1117. Thus, audio data included in a moving image file linked to a simple website is played, for example.

Note that, in the same way as with the case of e-mail, the cellular telephone 1100 may record (store) the received data linked to a simple website or the like in the storage unit 1123 via the recording/playing unit 1162.

Also, the cellular telephone 1100 analyzes the imaged two-dimensional code obtained by the CCD camera 1116 at the main control unit 1150, whereby information recorded in the two-dimensional code can be obtained.

Further, the cellular telephone 1100 can communicate with an external device at the infrared communication unit 1181 using infrared rays.

The cellular telephone 1100 employs the image encoding device 100 as the image encoder 1153, and thus, at the time of encoding and transmitting image data generated at the CCD camera 1116, for example, can apply skip mode and direct mode to rectangular motion partitions in the image data so as to be encoded, thereby improving encoding efficiency.

Also, the cellular telephone 1100 employs the image decoding device 200 as the image decoder 1156, and thus can correctly decode code streams where data (encoded data) of a moving image file linked to at a simple website or the like, for example, has been encoded with skip mode and direct mode applied to rectangular motion partitions, and thereby can improve encoding efficiency.

Note that description has been made so far wherein the cellular telephone 1100 employs the CCD camera 1116, but the cellular telephone 1100 may employ an image sensor (CMOS image sensor) using CMOS (Complementary Metal Oxide Semiconductor) instead of this CCD camera 1116. In this case as well, the cellular telephone 1100 can image a subject and generate the image data of an image of the subject in the same way as with the case of employing the CCD camera 1116.

Also, description has been made so far regarding the cellular telephone 1100, but the image encoding device 100 and the image decoding device 200 may be applied to any kind of device in the same way as with the case of the cellular telephone 1100 as long as it is a device having the same imaging function and communication function as those of the cellular telephone 1100, for example, such as a PDA (Personal Digital Assistants), smart phone, UMPC (Ultra Mobile Personal Computer), net book, notebook-sized personal computer, or the like.

### 6. Sixth Embodiment

### [Hard Disk Recorder]

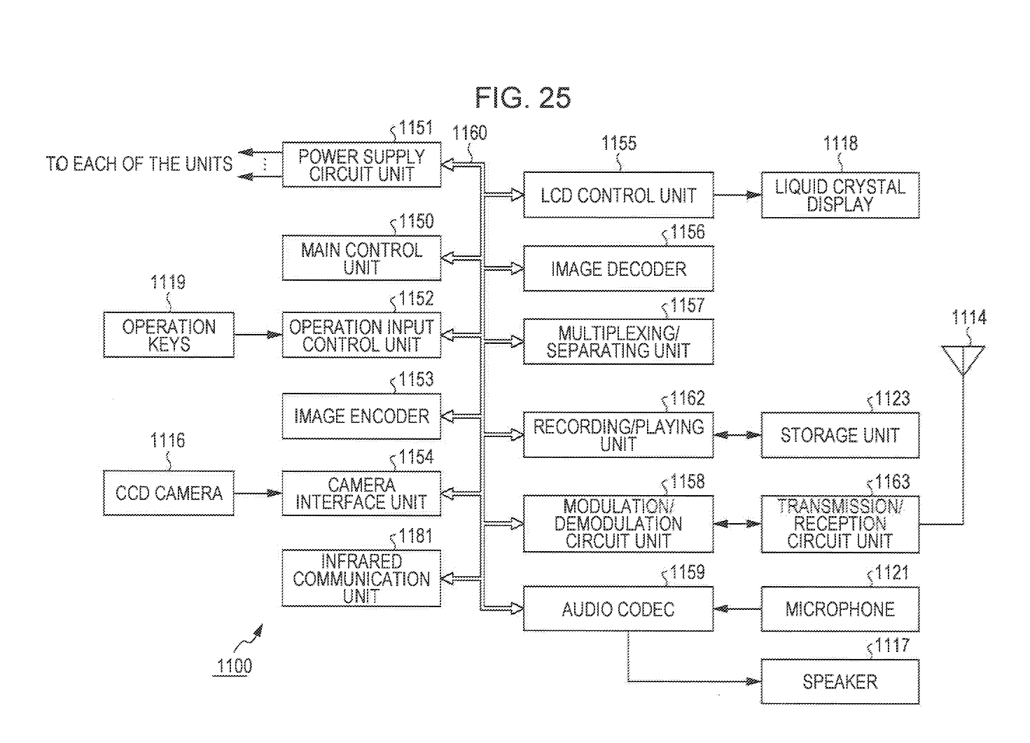

FIG. 25 is a block diagram illustrating a principal configuration example of a hard disk recorder which employs the image encoding device 100 and image decoding device 200.

A hard disk recorder (HDD recorder) 1200 shown in FIG. 25 is a device which stores, in a built-in hard disk, audio data and video data of a broadcast program included in broadcast wave signals (television signals) received by a tuner and transmitted from a satellite or a terrestrial antenna or the like, and provides the stored data to the user at timing according to the user's instructions.

The hard disk recorder 1200 can extract audio data and video data from broadcast wave signals, decode these as appropriate, and store in the built-in hard disk, for example. Also, the hard disk recorder 1200 can also obtain audio data and video data from another device via the network, decode these as appropriate, and store in the built-in hard disk, for example.

Further, the hard disk recorder 1200 can decode audio data and video data recorded in the built-in hard disk, supply this to a monitor 1260, display an image thereof on the screen of the monitor 1260, and output audio thereof from the speaker of the monitor 1260, for example. Also, the hard disk recorder 1200 can decode audio data and video data extracted from broadcast signals obtained via a tuner, or audio data and video data obtained from another device via a network, supply this to the monitor 1260, display an image thereof on the screen of the monitor 1260, and output audio thereof from the speaker of the monitor 1260, for example.

Of course, operations other than these may be performed.

As shown in FIG. 25, the hard disk recorder 1200 includes a reception unit 1221, a demodulation unit 1222, a demultiplexer 1223, an audio decoder 1224, a video decoder 1225, and a recorder control unit 1226. The hard disk recorder 1200 further includes EPG data memory 1227, program memory 1228, work memory 1229, a display converter 1230, an OSD (On Screen Display) control unit 1231, a display control unit 1232, a recording/playing unit 1233, a D/A converter 1234, and a communication unit 1235.

Also, the display converter 1230 includes a video encoder 1241. The recording/playing unit 1233 includes an encoder 1251 and a decoder 1252.

The reception unit 1221 receives the infrared signal from the remote controller (not shown), converts into an electrical signal, and outputs to the recorder control unit 2226. The recorder control unit 1226 is configured of, for example, a microprocessor and so forth, and executes various types of processing in accordance with the program stored in the program memory 1228. At this time, the recorder control unit 1226 uses the work memory 1229 according to need.

The communication unit 1235, which is connected to the network, performs communication processing with another device via the network. For example, the communication unit 1235 is controlled by the recorder control unit 1226 to communicate with a tuner (not shown), and to principally output a channel selection control signal to the tuner.

The demodulation unit 1222 demodulates the signal supplied from the tuner, and outputs to the demultiplexer 1223. The demultiplexer 1223 separates the data supplied from the demodulation unit 1222 into audio data, video data, and EPG data, and outputs to the audio decoder 1224, video decoder 1225, and recorder control unit 1226, respectively.

The audio decoder 1224 decodes the input audio data, and outputs to the recording/playing unit 1233. The video decoder 1225 decodes the input video data, and outputs to the display converter 1230. The recorder control unit 1226 supplies the input EPG data to the EPG data memory 1227 for storing.

The display converter 1230 encodes the video data supplied from the video decoder 1225 or recorder control unit 1226 into, for example, the video data conforming to the NTSC (National Television Standards Committee) format using the video encoder 1241, and outputs to the recording/playing unit 1233. Also, the display converter 1230 converts the size of the screen of the video data supplied from the video decoder 1225 or recorder control unit 1226 into the size corresponding to the size of the monitor 1260, converts into the video data conforming to the NTSC format using the video encoder 1241, converts into an analog signal, and outputs to the display control unit 1232.

The display control unit 1232 superimposes, under the control of the recorder control unit 1226, the OSD signal output from the OSD (On Screen Display) control unit 1231 on the video signal input from the display converter 1230, and outputs to the display of the monitor 1260 for display.

Also, the audio data output from the audio decoder 1224 has been converted into an analog signal, using the D/A converter 1234, and supplied to the monitor 1260. The monitor 1260 outputs this audio signal from a built-in speaker.

The recording/playing unit 1233 includes a hard disk as a recording medium in which video data, audio data, and so forth are recorded.

The recording/playing unit 1233 encodes the audio data supplied from the audio decoder 1224 by the encoder 1251, for example. Also, the recording/playing unit 1233 encodes the video data supplied from the video encoder 1241 of the display converter 1230 by the encoder 1251. The recording/playing unit 1233 synthesizes the encoded data of the audio data thereof, and the encoded data of the video data thereof using the multiplexer. The recording/playing unit 1233 amplifies the synthesized data by channel coding, and writes the data thereof in the hard disk via a recording head.

The recording/playing unit 1233 plays the data recorded in the hard disk via a playing head, amplifies, and separates into audio data and video data using the demultiplexer. The recording/playing unit 1233 decodes the audio data and video data by the decoder 1252. The recording/playing unit 1233 converts the decoded audio data from digital to analog, and outputs to the speaker of the monitor 1260. Also, the recording/playing unit 1233 D/A converts the decoded video data, and outputs to the display of the monitor 1260.

The recorder control unit 1226 reads out the latest EPG data from the EPG data memory 1227 based on the user's instructions indicated by the infrared signal from the remote controller which is received via the reception unit 1221, and supplies to the OSD control unit 1231. The OSD control unit 1231 generates image data corresponding to the input EPG data, and outputs to the display control unit 1232. The display control unit 1232 outputs the video data input from the OSD control unit 1231 to the display of the monitor 1260 for display. Thus, EPG (Electronic Program Guide) is displayed on the display of the monitor 1260.

Also, the hard disk recorder 1200 can obtain various types of data such as video data, audio data, EPG data, and so forth supplied from another device via the network such as the Internet or the like.

The communication unit 1235 is controlled by the recorder control unit 1226 to obtain encoded data such as video data, audio data, EPG data, and so forth transmitted from another device via the network, and to supply this to the recorder control unit 1226. The recorder control unit 1226 supplies the encoded data of the obtained video data and audio data to the recording/playing unit 1233, and stores in the hard disk, for example. At this time, the recorder control unit 1226 and recording/playing unit 1233 may perform processing such as re-encoding or the like according to need.

Also, the recorder control unit 1226 decodes the encoded data of the obtained video data and audio data, and supplies the obtained video data to the display converter 1230. The display converter 1230 processes, in the same way as the video data supplied from the video decoder 1225, the video data supplied from the recorder control unit 1226, supplies to the monitor 1260 via the display control unit 1232 for displaying an image thereof.

Alternatively, an arrangement may be made wherein in accordance with this image display, the recorder control unit 1226 supplies the decoded audio data to the monitor 1260 via the D/A converter 1234, and outputs audio thereof from the speaker.

Further, the recorder control unit 1226 decodes the encoded data of the obtained EPG data, and supplies the decoded EPG data to the EPG data memory 1227.

The hard disk recorder 1200 thus configured employs the image decoding device 200 as the video decoder 1225, decoder 1252, and decoder housed in the recorder control unit 1226. Accordingly, in the same way as with the image decoding device 200, the video decoder 1225, decoder 1252, and decoder housed in the recorder control unit 1226 can detect skip mode and direct mode of rectangular motion partitions and perform decoding processing in the respective modes, in the same way as with the image decoding device 200. Accordingly, the video decoder 1225, decoder 1252, and decoder housed in the recorder control unit 1226 can correctly decode code streams where skip mode and direct mode are applied to rectangular motion partitions, and thereby can improve encoding efficiency.

Accordingly, the hard disk recorder 1200 can correctly decode code streams even in cases where video data (encoded data) received via the tuner or communication unit 1235, and video data (encoded data) to be played by the recording/playing unit 1233, for example has been encoded with skip mode and direct mode applied to rectangular motion partitions, and thereby can improve encoding efficiency.

Also, the hard disk recorder 1200 employs the image encoding device 100 as the encoder 1251. Accordingly, with the encoder 1251, in the same way as with the case of the image encoding device 100, the skip mode and direct mode are applied to rectangular partitions as well, with motion vector information being calculated as one candidate mode, and cost functions being evaluated. Accordingly, the encoder 1251 can apply skip mode and direct mode to a greater region, and can improve encoding efficiency.

Accordingly, the hard disk recorder 1200 can apply skip mode and direct mode to rectangular motion partitions of image data to be recorded, at the time of generating encoded data to be recorded to a hard disk, for example, and thus encoded, thereby improving encoding efficiency.

Note that description has been made so far regarding the hard disk recorder 1200 for recording video data and audio data in the hard disk, but it goes without saying that any kind of recording medium may be employed. For example, even with a recorder to which a recording medium other than a hard disk, such as flash memory, optical disc, video tape, or the like, is applied, the image encoding device 100 and image decoding device 200 can be applied thereto in the same way as with the case of the above-described hard disk recorder 1200.

### 7. Seventh Embodiment

### [Camera]

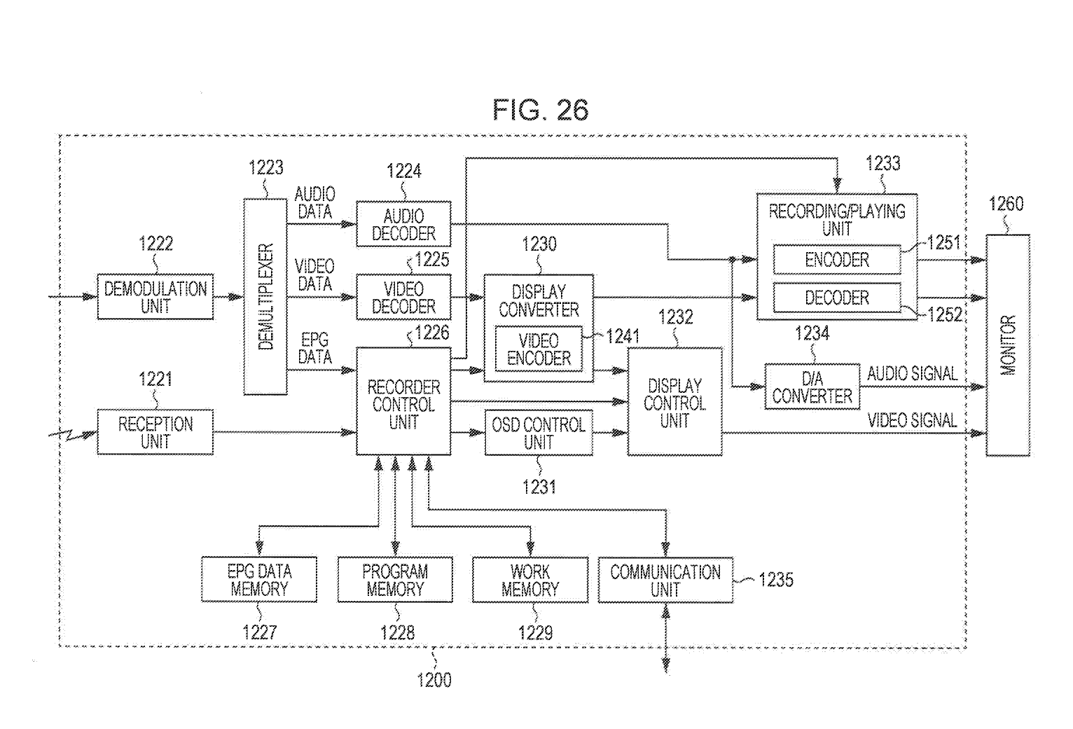

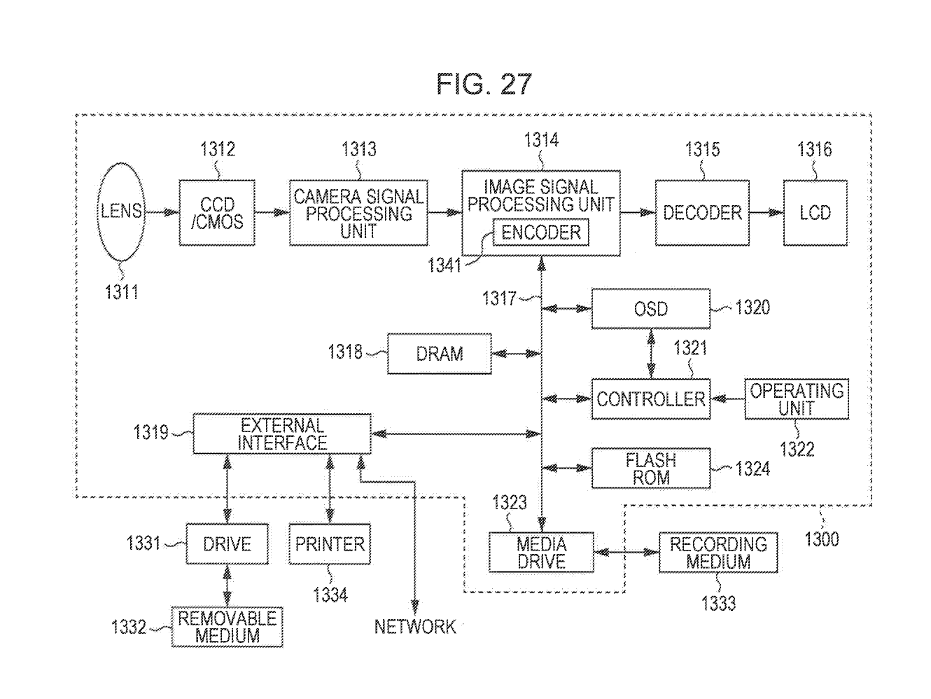

FIG. 26 is a block diagram illustrating a principal configuration example of a camera employing the image encoding device 100 and image decoding device 200.

A camera 1300 shown in FIG. 26 images a subject, displays an image of the subject on an LCD 1316, and records this in a recording medium 1333 as image data.

A lens block 1311 inputs light (i.e., picture of a subject) to a. CCD/CMOS 1312. The CCD/CMOS 1312 is an image sensor employing a CCD or CMOS, which converts the intensity of received light into an electrical signal, and supplies to a camera signal processing unit 1313.

The camera signal processing unit 1313 converts the electrical signal supplied from the CC/CMOS 1312 into color difference signals of Y, Cr, and Cb, and supplies to an image signal processing unit 1314. The image signal processing unit 1314 subjects, under the control of a controller 1321, the image signal supplied from the camera signal processing unit 1313 to predetermined image processing, or encodes the image signal thereof by an encoder 1341 using the MPEG format for example. The image signal processing unit 1314 supplies encoded data generated by encoding an image signal, to a decoder 1315. Further, the image signal processing unit 1314 obtains data for display generated at an on-screen display (OSD) 1320, and supplies this to the decoder 1315.

With the above-mentioned processing, the camera signal processing unit 1313 appropriately takes advantage of DRAM (Dynamic Random Access Memory) 1318 connected via a bus 1317 to hold image data, encoded data encoded from the image data thereof, and so forth in the DRAM 1318 thereof according to need.

The decoder 1315 decodes the encoded data supplied from the image signal processing unit 1314, and supplies obtained image data (decoded image data) to the LCD 1316. Also, the decoder 1315 supplies the data for display supplied from the image signal processing unit 1314 to the LCD 1316. The LCD 1316 synthesizes the image of the decoded image data, and the image of the data for display, supplied from the decoder 1315 as appropriate, and displays a synthesizing image thereof.

The on-screen display 1320 outputs, under the control of the controller 1321, data for display such as a menu screen or icon or the like made up of a symbol, characters, or a figure to the image signal processing unit 1314 via the bus 1317.

Based on a signal indicating the content commanded by the user using an operating unit 1322, the controller 1321 executes various types of processing, and also controls the image signal processing unit 1314, DRAM 1318, external interface 1319, on-screen display 1320, media drive 1323, and so forth via the bus 1317. Programs, data, and so forth necessary for the controller 1321 executing various types of processing are stored in FLASH ROM 1324.

For example, the controller 1321 can encode image data stored in the DRAM 1318, or decode encoded data stored in the DRAM 1318 instead of the image signal processing unit 1314 and decoder 1315. At this time, the controller 1321 may perform encoding and decoding processing using the same format as the encoding and decoding format of the image signal processing unit 1314 and decoder 1315, or may perform encoding/decoding processing using a format that neither the image signal processing unit 1314 nor the decoder 1315 can handle.

Also, for example, in the event that start of image printing has been instructed from the operating unit 1322, the controller 1321 reads out image data from the DRAM 1318, and supplies this to a printer 1334 connected to the external interface 1319 via the bus 1317 for printing.

Further, for example, in the event that image recording has been instructed from the operating unit 1322, the controller 1321 reads out encoded data from the DRAM 1318, and supplies this to a recording medium 1333 mounted on, the media drive 1323 via the bus 1317 for storing.

The recording medium 1333 is an optional readable/writable removable medium, for example, such as a magnetic disk, a magneto-optical disk, an optical disc, semiconductor memory, or the like. It goes without saying that the recording medium 1333 is also optional regarding the type of a removable medium, and accordingly may be a tape device, or may be a disk, or may be a memory card. It goes without saying that the recoding medium 1333 may be a non-contact IC card or the like.

Alternatively, the media drive 1323 and the recording medium 1333 may be configured so as to be integrated into a non-transportable recording medium, for example, such as a built-in hard disk drive, SSD (Solid State Drive), or the like.

The external interface 1319 is configured of, for example, a USB input/output terminal and so forth, and is connected to the printer 1334 in the event of performing printing of an image. Also, a drive 1331 is connected to the external interface 1319 according to need, on which the removable medium 1332 such as a magnetic disk, optical disc, or magneto-optical disk is mounted as appropriate, and a computer program read out therefrom is installed in the FLASH ROM 1324 according to need.

Further, the external interface 1319 includes a network interface to be connected to a predetermined network such as a LAN, the Internet, or the like. For example, in accordance with the instructions from the operating unit 1322, the controller 1321 can read out encoded data from the DRAM 1318, and supply this from the external interface 1319 to another device connected via the network. Also, the controller 1321 can obtain, via the external interface 1319, encoded data or image data supplied from another device via the network, and hold this in the DRAM 1318, or supply this to the image signal processing unit 1314.

The camera 1300 thus configured employs the image decoding device 200 as the decoder 1315. Accordingly, in the same way as with the image decoding device 200, the decoder 1315 can detect skip mode and direct mode of rectangular motion partitions and perform decoding processing in the respective modes. Accordingly, the decoder 1315 can correctly decode code streams where skip mode and direct mode are applied to rectangular motion partitions, and thereby can improve encoding efficiency.

Accordingly, the camera 1300 can correctly decode code streams even in cases where image data generated at the CCD/CMOS 1312, encoded data of video data read out from the DRAM 1318 or recording medium 1333, and encoded data of video data obtained via a network, have been encoded with skip mode and direct mode applied to rectangular motion partitions, and thereby can improve encoding efficiency.

Also, the camera 1300 employs the image encoding device 100 as the encoder 1341. Accordingly, in the same way as with the case of the image encoding device 100, the encoder 1341 can apply the skip mode and direct mode to rectangular partitions as well, with motion vector information being calculated as one candidate mode, and cost functions being evaluated. Accordingly, the encoder 1341 can apply skip mode and direct mode to a greater region, and can improve encoding efficiency.

Accordingly, the camera 1300 can apply the skip mode and direct mode to rectangular partitions to recorded or provided image data at the time of generating encoded data recorded in the DRAM 1318 or recording medium 1333, and encoded data provided to other devices, so as to be encoded, thereby improving encoding efficiency.

Note that the decoding method of the image decoding device 200 may be applied to the decoding processing which the controller 1321 performs. In the same way, the encoding method of the image encoding device 100 may be applied to the encoding processing which the controller 1321 performs.

Also, the image data which the camera 1300 takes may be moving images or may be still images.

As a matter of course, the image encoding device 100 and image decoding device 200 may be applied to devices or systems other than the above-described devices.

Note that the present technology can be applied to image encoding devices and image decoding devices used for receiving image information (bit stream) compressed by orthogonal transform such as discrete cosine transform or the like, and motion compensation, as with MPEG, H.26x, or the like, via network media such as satellite broadcasting, cable television, the Internet, cellular phones, or the like. Also, the present technology can be applied to image encoding devices and image decoding devices used for processing on storage media such as optical discs, magnetic disks, flash memory, and so forth.

Note that the present technology may assume the following configurations as well.

(1) An image processing device, including:

a motion prediction/compensation unit configured to perform motion prediction/compensation in a prediction mode regarding which there is no need to transmit a generated motion vector to a decoding side, and in which the motion vector is generated with regard to a motion partition which is a partial region of an image to be encoded and is a non-square motion prediction/compensation processing increment, the generating being performed using motion vectors of surrounding motion partitions that have already been generated; and

an encoding unit configured to encode difference information between a prediction image generated by motion prediction/compensation performed by the motion prediction/compensation unit, and the image.

(2) The image processing device according to (1), further including:

a flag generating unit configured to generate, in the event of the motion prediction/compensation unit performing motion prediction/compensation as to the non-square motion partition, flag information indicating whether or not to perform motion prediction/compensation in the prediction mode.

(3) The image processing device according to (2), wherein, in the event of the motion prediction/compensation unit performing motion prediction/compensation as to the non-square motion partition in the prediction mode, the flag generating unit sets the value of the flag information to 1, and in the event of performing motion prediction/compensation in a mode other than the prediction mode, sets the flag information value to 0.

(4) The image processing device according to either (2) or (3), wherein the encoding unit encodes the flag information generated by the flag generating unit along with the difference information.

(5) The image processing device according to any one of (1) through (4), wherein the motion partition is a non-square sub macroblock, dividing a macroblock, which is a partial region of the image to be encoded, and which is an encoding processing increment, and which is greater than a predetermined size, into a plurality.

(6) The image processing device according to (5), wherein the predetermined size is 16×16 pixels.

(7) The image processing device according to either (5) or (6), wherein the sub macroblock is a rectangle.

(8) The image processing device according to any one of (5) through (7), wherein the sub macroblock is a region dividing the macroblock into two.

(9) The image processing device according to (8), wherein the sub macroblock is a region asymmetrically dividing the macroblock into two.

(10) The image processing device according to (8), wherein the sub macroblock is a region obliquely dividing the macroblock into two.

(11) An image processing method of an image processing device, the method including:

a motion prediction/compensation unit performing motion prediction/compensation in a prediction mode regarding which there is no need to transmit a generated motion vector to a decoding side, and in which the motion vector is generated with regard to a motion partition which is a partial region of an image to be encoded and is a non-square motion prediction/compensation processing increment, the generating being performed using motion vectors of surrounding motion partitions that have already been generated; and

an encoding unit encoding difference information between a prediction image generated by motion prediction/compensation that has been performed, and the image.

(12) An image processing device, including:

a decoding unit configured to decode a code stream in which is encoded different information between
a prediction image generated by having performed motion prediction/compensation in a prediction mode regarding which there is no need to transmit a generated motion vector to a decoding side, and in which the motion vector is generated with regard to a motion partition which is a partial region of an image to be encoded and is a non-square motion prediction/compensation processing increment, the generating being performed using motion vectors of surrounding motion partitions that have already been generated, and
the image;

a motion prediction/compensation unit configured to perform motion prediction/compensation on the non-square motion partition in the prediction mode, generate the motion vector using motion vector information of the surrounding motion partitions obtained by the code stream having been decoded by the decoding unit, and generate the prediction image; and

a generating unit configured to generate a decoded image by adding the difference information obtained by the code stream having been decoded by the decoding unit, and the prediction image generated by the motion prediction/compensation unit.

(13) The image processing device according to (12), wherein the motion prediction/compensation unit performs motion prediction/compensation of the non-square motion partition in the prediction mode, in the event that flag information which has been decoded by the decoding unit and which indicates whether or not motion prediction/compensation has been performed in the prediction mode, indicates that the non-square motion partition has been subjected to motion prediction/compensation in the prediction mode.

(14) The image processing device according to either (12) or (13), wherein the motion partition is a non-square sub macroblock, dividing a macroblock, which is a partial region of the image to be encoded, and which is an encoding processing increment, and which is greater than a predetermined size, into a plurality.

(15) The image processing device according to (14), wherein the predetermined size is 16×16 pixels.

(16) The image processing device according to either (14) or (15), wherein the sub macroblock is a rectangle.

(17) The image processing device according to any one of (14) through (17), wherein the sub macroblock is a region dividing the macroblock into two.

(18) The image processing device according to (17), wherein the sub macroblock is a region asymmetrically dividing the macroblock into two.

(19) The image processing device according to (17), wherein the sub macroblock is a region obliquely dividing the macroblock into two.

(20) An image processing method of an image processing device, the method including:

a decoding unit decoding a code stream in which is encoded different information between
a prediction image generated by having performed motion prediction/compensation in a prediction mode regarding which there is no need to transmit a generated motion vector to a decoding side, and in which the motion vector is generated with regard to a motion partition which is a partial region of an image to be encoded and is a non-square motion prediction/compensation processing increment, the generating being performed using motion vectors of surrounding motion partitions that have already been generated, and
the image;

a motion prediction/compensation unit performing motion prediction/compensation on the non-square motion partition in the prediction mode, generating the motion vector using motion vector information of the surrounding motion partitions obtained by the code stream having been decoded, and generating the prediction image; and

a generating unit generating a decoded image by adding the difference information obtained by the code stream having been decoded, and the generated prediction image.

### REFERENCE SIGNS LIST

100 image encoding device
115 motion prediction/compensation unit
131 cost function calculating unit
132 motion searching unit
133 square skip/direct encoding unit
134 rectangular skip/direct encoding unit
135 mode determining unit
136 motion compensation unit
137 motion vector buffer
151 motion vector obtaining unit
152 flag generating unit
153 cost function calculating unit
171 adjacent partition defining unit
172 motion vector generating unit
200 image decoding unit
212 motion prediction/compensation unit
231 motion vector buffer
232 mode buffer
233 square skip/direct decoding unit
234 rectangular skip/direct decoding unit
235 motion compensation unit
251 adjacent partition defining unit
252 motion vector generating unit

1. An image processing device, comprising:
a motion prediction/compensation unit configured to perform motion prediction/compensation in a prediction mode regarding which there is no need to transmit a generated motion vector to a decoding side, and in which the motion vector is generated with regard to a motion partition which is a partial region of an image to be encoded and is a non-square motion prediction/compensation processing increment, the generating being performed using motion vectors of surrounding motion partitions that have already been generated; and
an encoding unit configured to encode difference information between a prediction image generated by motion prediction/compensation performed by the motion prediction/compensation unit, and the image.

2. The image processing device according to claim 1, further comprising:
a flag generating unit configured to generate, in the event of the motion prediction/compensation unit performing motion prediction/compensation as to the non-square motion partition, flag information indicating whether or not to perform motion prediction/compensation in the prediction mode.

3. The image processing device according to claim 2, wherein, in the event of the motion prediction/compensation unit performing motion prediction/compensation as to the non-square motion partition in the prediction mode, the flag generating unit sets the value of the flag information to 1, and in the event of performing motion prediction/compensation in a mode other than the prediction mode, sets the flag information value to 0.

4. The image processing device according to claim 2, wherein the encoding unit encodes the flag information generated by the flag generating unit along with the difference information.

5. The image processing device according to claim 1, wherein the motion partition is a non-square sub macroblock, dividing a macroblock, which is a partial region of the image to be encoded, and which is an encoding processing increment, and which is greater than a predetermined size, into a plurality.

6. The image processing device according to claim 5, wherein the predetermined size is 16×16 pixels.

7. The image processing device according to claim 5, wherein the sub macroblock is a rectangle.

8. The image processing device according to claim 5, wherein the sub macroblock is a region dividing the macroblock into two.

9. The image processing device according to claim 8, wherein the sub macroblock is a region asymmetrically dividing the macroblock into two.

10. The image processing device according to claim 8, wherein the sub macroblock is a region obliquely dividing the macroblock into two.

11. An image processing method of an image processing device, the method comprising:
a motion prediction/compensation unit performing motion prediction/compensation in a prediction mode regarding which there is no need to transmit a generated motion vector to a decoding side, and in which the motion vector is generated with regard to a motion partition which is a partial region of an image to be encoded and is a non-square motion prediction/compensation processing increment, the generating being performed using motion vectors of surrounding motion partitions that have already been generated; and
an encoding unit encoding difference information between a prediction image generated by motion prediction/compensation that has been performed, and the image.

12. An image processing device, comprising:
a decoding unit configured to decode a code stream in which is encoded different information between
a prediction image generated by having performed motion prediction/compensation in a prediction mode regarding which there is no need to transmit a generated motion vector to a decoding side, and in which the motion vector is generated with regard to a motion partition which is a partial region of an image to be encoded and is a non-square motion prediction/compensation processing increment, the generating being performed using motion vectors of surrounding motion partitions that have already been generated, and
the image;
a motion prediction/compensation unit configured to perform motion prediction/compensation on the non-square motion partition in the prediction mode, generate the motion vector using motion vector information of the surrounding motion partitions obtained by the code stream having been decoded by the decoding unit, and generate the prediction image; and
a generating unit configured to generate a decoded image by adding the difference information obtained by the code stream having been decoded by the decoding unit, and the prediction image generated by the motion prediction/compensation unit.

13. The image processing device according to claim 12, wherein the motion prediction/compensation unit performs motion prediction/compensation of the non-square motion partition in the prediction mode, in the event that flag information which has been decoded by the decoding unit and which indicates whether or not motion prediction/compensation has been performed in the prediction mode, indicates that the non-square motion partition has been subjected to motion prediction/compensation in the prediction mode.

14. The image processing device according to claim 12, wherein the motion partition is a non-square sub macroblock, dividing a macroblock, which is a partial region of the image to be encoded, and which is an encoding processing increment, and which is greater than a predetermined size, into a plurality.

15. The image processing device according to claim 14, wherein the predetermined size is 16×16 pixels.

16. The image processing device according to claim 14, wherein the sub macroblock is a rectangle.

17. The image processing device according to claim 14, wherein the sub macroblock is a region dividing the macroblock into two.

18. The image processing device according to claim 17, wherein the sub macroblock is a region asymmetrically dividing the macroblock into two.

19. The image processing device according to claim 17, wherein the sub macroblock is a region obliquely dividing the macroblock into two.

20. An image processing method of an image processing device, the method comprising:
a decoding unit decoding a code stream in which is encoded different information between
a prediction image generated by having performed motion prediction/compensation in a prediction mode regarding which there is no need to transmit a generated motion vector to a decoding side, and in which the motion vector is generated with regard to a motion partition which is a partial region of an image to be encoded and is a non-square motion prediction/compensation processing increment, the generating being performed using motion vectors of surrounding motion partitions that have already been generated, and
the image;
a motion prediction/compensation unit performing motion prediction/compensation on the non-square motion partition in the prediction mode, generating the motion vector using motion vector information of the surrounding motion partitions obtained by the code stream having been decoded, and generating the prediction image; and
a generating unit generating a decoded image by adding the difference information obtained by the code stream having been decoded, and the generated prediction image.
